(19) United States
(12) Patent Application Publication
(10) Pub. No.: US 2008/0258339 A1
(43) Pub. Date: Oct. 23, 2008

(54) Method for the Production of a Substrate Having a Holographic Appearance

(75) Inventor: Wayne Ernest Conrad, Hampton (CA)

Correspondence Address: BERESKIN AND PARR, 40 KING STREET WEST, BOX 401, TORONTO, ON, M5H 3Y2, CA

(73) Assignee: 2089275 ONTARIO LTD., Richmond Hill, ON (CA)

(21) Appl. No.: 11/571,310

(22) PCT Filed: Oct. 18, 2005
(86) PCT No.: PCT/CA2005/001577

§ 371 Date: May 7, 2008

Related U.S. Application Data
(60) Provisional application No. 60/621,669, filed on Oct. 26, 2004.
(60) Provisional application No. 60/624,547, filed on Nov. 4, 2004.
(60) Provisional application No. 60/654,937, filed on Feb. 23, 2005.
(60) Provisional application No. 60/654,941, filed on Feb. 23, 2005.
(60) Provisional application No. 60/654,938, filed on Feb. 23, 2005.

(51) Int. Cl. B28B 11/08

(52) U.S. Cl. 264/293

(57) ABSTRACT

A means of digitizing the topography of an art work is disclosed. A means of reproducing said art work and the related apparatus are also disclosed. The art reproduction process disclosed employs a thin sheet of thermoformable plastic onto which a permanent image of an art work has been created and which is heated prior to either a dot matrix print head, a daisy wheel print head, or both being employed to apply mechanical force to said thin sheet of thermoformable plastic sheet so as to create an accurate three-dimensional relief reproduction of an original artwork. An alternative embodiment is also disclosed wherein the art reproduction process employs a thin sheet of paper or cardboard onto which a permanent image of an art work has been created and which is heated and humidified with steam prior to either a dot matrix print head, a daisy wheel print head, or both being employed to apply mechanical force to said thin paper or cardboard sheet so as to create an accurate three-dimensional relief reproduction of an original artwork.

### FIELD OF THE INVENTION

This invention relates to the production of a substrate having a textured surface (e.g., a relatively thin sheet that is treated such as by pressure and/or vacuum molding to provide a topography or relief pattern therein), utilizing an original object, wherein the substrate has a holographic appearance. The original object may be a three-dimensional object or, alternately, it may be a non-textured substrate (e.g. a photograph). In one particularly preferred embodiment, the method relates to producing a reproduction that is larger or smaller than the original object wherein, in the reproduction, the depth of the reproduction in the Z dimension, or the texture of the reproduction, is scaled from the starting object to a different degree then the length or width of the starting object in the X and/or Y dimensions.

### BACKGROUND OF THE INVENTION

Various different techniques have been developed for the inexpensive reproduction of original works of art. For example, a mold for use in vacuum molding may be prepared by applying a liquid silicone rubber compound to the surface of an original work of art, allowing the rubber compound to cure to produce a rubber mold. The rubber mold is then subsequently used to create a metal mold, which is then used to create reproductions. Such processes have limited acceptability as they may jeopardize the physical integrity of the original work of art. Accordingly, an alternate method for reproducing an original work of art comprises using a person with artistic ability to copy an original work of art thereby creating an artwork that may then be used to produce a mold that is utilized in vacuum molding. Therefore, there is no risk of damage to the original work of art. See for example U.S. Pat. Nos. 3,748,202, 3,880,686, 4,001,062, 4,971,743 and 5,958,470. One disadvantage of this approach is that, to avoid risk of damage to an original artwork, an artist must be employed each time a different artwork is to be reproduced. Further, the reproduction is of a copy and not the original. Further, an artwork cannot be quickly reproduced without risk of damage since time must be provided for the artist to produce the copy.

It is also been known to create embossing dies, which are then used to create reproductions. See for example U.S. Pat. No. 5,182,063.

If a mold is produced from a work of art, whether an original or a copy, a male mold is first produced. The male mold is subsequently used to make a female mold, which is then used to vacuum form a thermoformable plastic sheet. The female mold may be prepared by pouring onto the surface of a male mold a suitable castable material which, when hardened and released from the male mold, provides a female mold having the reverse texture present in the male mold. Such castable material has a tendency to shrink as it hardens. For example, epoxy resins experience considerable shrinkage during the curing process. Accordingly, to overcome the problems associated with the use of castable shrinkable material, the male mold may be enlarged sufficiently to account for the shrinkage that will occur when the female mold is made. Accordingly, a picture may be taken of the original, digitally stored and then printed onto a sheet. The picture image is expanded from the original size of the picture to an expanded dimensional size wherein the length and width are expanded to an extent to which the female mold shrinks from its original poured state to its hardened state. A hardened compound is brushed onto the printed expanded image to replicate the brush strokes of the original picture image thereby creating a male mold. The female mold is then prepared by pouring a castable shrinkable material onto the male mold and curing the castable shrinkable material. See U.S. Pat. No. 6,444,148. One disadvantage of this approach is that the texture in the reproduction is again of a copy an original.

### SUMMARY OF THE INVENTION

In accordance with one aspect of the instant invention, there is provided a method and apparatus for the production of a substrate wherein the substrate has a holographic appearance.

The substrate may be a reproduction of an oil painting that has a relief surface. The substrate may be prepared by using a relief mold taken from the original oil painting or derived from the original oil painting. A thermoplastic sheet, imprinted with a color picture corresponding to the original oil painting, may be subjected to vacuum and/or pressure molding to form a relief image in the substrate. Therefore, the substrate bears a picture of the original oil painting and a relief pattern that is based on the relief pattern of the original oil painting—e.g. the brush strokes in the original oil painting. Alternately, the substrate may be a reproduction of a photograph or other two-dimensional artistic work. In this embodiment, the original does not have a relief pattern. Instead, a relief pattern may be developed from the objects in the photograph using a computer algorithm.

In any case, the substrate is shaped and the selection of the front face bearing a positive or a negative of the work image is made so that the three dimensional representation has a holographic appearance. Preferably, the front face of the substrate displays a negative version of the image and the substrate is shaped so that the front face is generally concave when viewed from the front. Typically, art reproductions have been prepared by preparing a female mold (i.e. a mold that contains a relief pattern that is the reverse or a negative image of the original artwork). The use of such a mold results in a substrate that bears a positive image on its front face. A substrate having a negative image on its front face may be obtained by, e.g., preparing a male mold (i.e. a mold that contains a relief pattern that is the same or a positive image of the original artwork). Therefore, when the mold is used, the substrate has a negative image provided on its front face. When viewed from the front, a substrate having a negative version of the image and shaped so that the front face is generally concave appears to be a holographic representation (i.e. the image appears to be convex) of a positive version of the image. Accordingly, one advantage of the instant invention is that a picture, poster, advertisement or the like may be prepared from an original artwork, or a computer generated file, wherein the printed and formed substrate is more visually attractive.

In one embodiment, a textured substrate may be prepared by acquiring an electronic file of an existing two-dimensional image (e.g., a non-textured substrate such as a non-textured picture) or of a three-dimensional object (such as an original oil painting) and preparing the reproduction wherein the ratio of the size of the original object (the length and/or width in the X and Y dimensions) are scaled on one basis and the texture or depth of the object in the Z dimension is scaled on a different scale.

A textured substrate is used to refer to a carrier member that has a topography or relief pattern therein. A substrate is typically an extent of material (e.g., a sheet) whose length and width are relatively large compared to the thickness of the material. An example of a substrate is a sheet of thermoformable plastic used in vacuum or pressure molding. For example, in one embodiment, the reproduction may be used as a billboard, poster or the like, or the reproduction may be of a picture. In such a case, the substrate is essentially flat except for the relief pattern that is provided in the substrate. In other words, the front or image bearing face of the substrate, except for the relief pattern provided therein, (i.e., the length and width of the substrate) extends in a two-dimensional plane.

Accordingly, the original object may be an original oil painting (a textured substrate). The length and width of the reproduction in the X and Y dimensions may, for example be ¼ the size of the original. In such a case, if the dimension of the brush strokes (i.e. the depth of the brush strokes in the Z dimension) were also scaled by ¼, then the topography or relief pattern in the reproduction would be subtler. Accordingly, the brush strokes may not appear to be realistic. One advantage of this embodiment of the instant invention is that by utilizing a different scale factor for texture (depth) as opposed to the length and width of an object, the reproduction may have a texture that is perceptible to an observer and is also realistic. For example, if the scale factor used for the Z dimension is one, then the brush strokes will have the same topography as the actual brush strokes in the original oil painting even though the size of the oil painting is altered. Therefore, the brush strokes may look realistic.

The original object may alternately be a photograph (a non-textured substrate) of, for example, an oil painting or a picture of a person. However, the subjects of the original photographs do contain texture. Accordingly, a digital picture may be taken of the object and a computer program utilized to create a work file, which includes information on the topography/depth of the subject of the photograph. An example of such an algorithm is set out in U.S. Pat. No. 6,515,659. Other such computer programs are known in the art. Accordingly, even if the original object does not have a textured surface, the rep reduction may have a textured surface that is based upon the subject of the original object.

The reproduction may be an advertisement, such as a poster, billboard or the like. In such a case, the advertisement is preferably expanded several fold (e.g. from about 2 to about 50 times the length and width of the original object). If the original object has a textured surface, or if a topography is produced using a computer program, then it may be desirable that the reproduction have a textured surface but wherein the textured surface of the reproduction is scaled at a different rate to the scale used in the X and Y dimensions. For example, in the case of a poster or billboard, it may be desirable to use a scale factor that is smaller than the scale factor utilized on the X and Y dimensions. If the same scale factor is used for the Z dimension, then the maximum length in the Z dimension may be such that the object does not appear proportional to an observer, does not fit within a case (for example if the poster is provided in a glass enclosure) or the substrate may be dimensionally unstable if it is exposed to the elements (e.g., part of the reproduction may sag or deform due to gravity or when subject to strong winds).

Another example is a textured advertisement that is provided, for example, for use on a desktop. In such a case, the original object may be a standard print advertisement (e.g. a non-textured photograph) provided by a client. In such a case, as discussed previously, a computer program may be utilized to provide the Z dimensions for the textured reproduction. However, in this case, it is preferable that the scale factor that is used for the length and width of the subject contained in the original photograph is scaled at a different scale to the depth of the subject of the original photograph. For example, the depth of the textured reproduction in the Z dimension may be scaled at a substantially reduced scale compared to the scaling utilized for the X and Y dimensions. In such a case, the advertisement has a bold appearance and will attract the attention of the user but will be able to be contained within a printed publication (such as a book, magazine, journal or the like).

It will be appreciated that the three-dimensional reproduction may be monotone. For example, the substrate may merely bear the topography of the object. Preferably, the reproduction also bears an image of the original object. The “image” of the original object is the equivalent of a two-dimensional reproduction of an object such as would be obtained by printing a picture of the object. The image contains two-dimensional data of the element or elements forming the object and may be black and white but is preferably colour. Accordingly, in a preferred embodiment, the three-dimensional reproduction contains the image of the object (which is obtained from the scaled X and Y data) and the relief pattern or topography of the object (which is derived from the scaled Z data). In a particularly preferred embodiment, the three-dimensional reproduction bears a colour reproduction of the image of the object.

The actual production methods that are employed to produce the three-dimensional reproduction may be any of those named in the art. The reproduction may be prepared by first printing an image on the substrate and then treating the substrate (e.g., by molding or by subjecting the surface to a three-dimensional printing process) to produce a topography. For example, the scaled XYZ data may be used to prepare a mold and the mold is subsequently used to prepare the reproduction. Accordingly, the scaled XY data may be used to print an image, preferably a colour image, on the substrate and the substrate is subsequently inserted into a mold whereby the three-dimensional reproduction is prepared. An example of a molding process is disclosed in U.S. Pat. No. 5,958,470.

Alternately, the scaled XYZ data may be used to directly produce the reproduction. For example, the scaled XY data may be used to apply an image, preferably a colour image, to the substrate (e.g. by a printing process) and the scaled Z data may be used to directly create the topography. For example, the topography comprises a plurality of depths in the Z dimension. The differing depths in the Z dimension may be formed in the substrate by applying a variable mechanical force in the Z direction to the surface of the substrate. The variable mechanical force may be applied for example, by a dot-matrix printing head, a daisy wheel printing head, a matrix of pins that are moveable in the Z dimension, an electronic deformable LCD, or any other means known in the art.

The mold may be prepared by any means known in the art. For example, the mold may be prepared by machining, laser cutting, CNC machining, CNC laser cutting, fused deposition modeling, 3D printing onto a plaster or similar powder substrate, stereo lithography and/or casting. According to one embodiment of the instant invention, there is provided a method of forming an image on a substrate, the substrate having a front face, the method comprising:
(a) acquiring electronic data representing a work image of an object, the work image including a three dimensional representation of the object; and,
(b) using the electronic data to prepare a three dimensional reproduction of the object on the substrate wherein the substrate is shaped and the selection of the front face bearing a positive or a negative of the work image is made so that the three dimensional representation has a holographic appearance.

In one embodiment, the method further comprises preparing the reproduction such that the front face of the substrate bears a negative version of the work image.

In another embodiment, the method further comprises providing a picture on the front face of the substrate.

In another embodiment, the electronic data includes information on colour to be applied to the substrate and the method further comprises providing colour to the front face of the substrate.

In another embodiment, the method further comprises shaping the substrate such that the front face is generally concave when viewed from the front.

In another embodiment, the electronic data is acquired by taking a picture of the object.

In another embodiment, the method further comprises using a camera to take the picture of the object.

In another embodiment, the method further comprises converting the picture taken by the camera to the electronic data.

In another embodiment, the method further comprises receiving the electronic data over the Internet.

In another embodiment, the method further comprises receiving the electronic data on a portable data storage medium.

In another embodiment, the object comprises at least one of an animal, a mammal and an article of manufacture and the method further comprises using the substrate as an advertisement.

In another embodiment, the work image includes a three dimensional representation of the object, wherein in the representation of the object has a length in each of the X, and Y dimensions and a plurality of depths in the Z dimension and the method further comprises processing the electronic data to obtain scaled XYZ data wherein at least one of X and Y are scaled by a first scale factor and Z is scaled by a second scale factor, the second scale factor being different from the first scale factor and using the scaled XYZ data in step (b) to prepare the reproduction of the object on the substrate.

In another embodiment, the reproduction has a texture and the method further comprises selecting the second scale factor so that the texture is perceptible.

In another embodiment, the object is a person and a first value for the second scale factor is used for at least one of the person's lips and eyebrows and a second value for the second scale factor is used for the person's nose.

In another embodiment, the object bears a two-dimensional image and the method further comprises producing the work image from the two dimensional image.

In another embodiment, the object, comprises a photograph or sketch of an object and the method further comprises producing the work image from the photograph or sketch.

In another embodiment, the work image is produced at a first location and stored in a computer readable file and the computer readable file is sent to a second location where the reproduction is produced.

In another embodiment, the second location is physically remote from the first location and the computer readable file is sent via a data transmission network.

In another embodiment, the reproduction is subsequently shipped to a customer.

In accordance with another embodiment of the instant invention, there is provided a method of forming an image on a substrate, the substrate having a front face, the method comprising:
(a) acquiring electronic data representing a work image of an object, the work image including a three dimensional representation of the object; and,
(b) using the electronic data to prepare a three dimensional reproduction of the object on the substrate wherein the front face of the substrate displays a negative version of the work image and the substrate is shaped so that the front face is generally concave when viewed from the front.

In accordance with another embodiment of the instant invention, there is provided a method of operating a photographic studio comprising:
(a) obtaining an image of at least one living animal or mammal; and,
(b) using the image to produce a 3D version of the image on a substrate.

In one embodiment, the method further comprises applying a two dimensional version of the image on a substrate and subsequently treating the substrate to obtain the 3D version of the image.

In another embodiment, the substrate is a deformable material and the method further comprises subjecting the substrate to pressure to form the 3D version of the image therein.

In another embodiment, the method further comprises treating the substrate to temporarily reduce the rigidity of the substrate.

In another embodiment, the substrate comprises a thermoformable plastic and the method further comprises subjecting the substrate to heat and pressure to form the 3D version of the image therein.

In another embodiment, the substrate comprises a cellulose substrate and the method further comprises subjecting the substrate to heat in the presence of water to form the 3D version of the image therein.

In another embodiment, the 3D version of the image is formed using rapid prototyping technology.

In another embodiment, the image is obtained from a two dimensional photograph and the method further comprises obtaining a work image from the two dimensional photograph and processing the work image to includes a three dimensional representation of the at least one living animal or mammal, wherein in the representation of the object has a length in each of the X, and Y dimensions and a plurality of depths in the Z dimension.

In another embodiment, the image is obtained by photographing at least one living animal or mammal at the photographic studio.

In another embodiment, the at least one living animal or mammal comprises a person and the method further comprises configuring the substrate to have a holographic appearance.

The substrate may be a direct copy of the original (in the X, Y and Z planes). Alternately, the substrate may be scaled. In such a case, all dimensions may be scaled using the same scale factor. Alternately, according to another embodiment of the instant invention, there is provided a method for producing a three dimensional reproduction of an, object comprising:
(a) acquiring electronic data representing a work image of the object, the work image including a three dimensional representation of the object, wherein in the representation of the object has a length in each of the X, and Y dimensions and a plurality of depths in the Z dimension;
(b) processing the electronic data to obtain scaled XYZ data wherein at least one of X and Y are scaled by a first scale factor and Z is scaled by a second scale factor, the second scale factor being different from the first scale factor; and,
(c) using the scaled XYZ data to prepare the reproduction of the object on a substrate.

In one embodiment, step (c) comprises using the scaled XYZ data to prepare a mold and using the mold to produce the reproduction.

In another embodiment, step (c) comprises using the scaled XYZ data to directly produce the reproduction.

In another embodiment, the processing includes:
(a) processing the electronic data with the first scale factor for scaling the length of at least one of the X and Y dimensions of the three dimensional representation of the object to provide a first scaled dataset; and,
(b) processing the first scaled dataset with a second scale factor for scaling the plurality of depths in the Z dimension of the three dimensional representation of the object to provide a second scaled dataset;

wherein the reproduction is prepared using the second scaled dataset.

In another embodiment, step (b) includes:
(a) processing the electronic data with a first scale factor for scaling the length of at least one of the X and Y dimensions of the three dimensional representation of the object to provide scaled XY data; and
(b) processing the electronic data by applying a rule based on the first scaling factor, wherein the rule represents the second scale factor, to obtain the scaled Z data.

In another embodiment, the length in the X dimension of the three dimensional representation of the object is varied by the first scale factor, the plurality of depths in the Z dimension of the three dimensional representation of the object is varied by the second scale factor and the length in the Y dimension of the three dimensional representation is varied by a third scale factor, wherein the third scale factor is from 80 to 120% of the first scale factor.

In another embodiment, the method further comprises selecting the second scale factor so that the reproduction has a realistic appearing texture.

In another embodiment, the reproduction has X and Y dimensions each having a length and a Z dimension with a plurality of depths and the method further comprises selecting the second scale factor so that, when the reproduction is viewed by a person, the length of the reproduction in each of the X, and Y dimensions and the plurality of depths of the reproduction in the Z dimension appears to have been scaled by the same scale factor.

In another embodiment, the reproduction has a texture and the method further comprises selecting the second scale factor so that the texture is perceptible.

In another embodiment, the reproduction has a visual focal point and the method further comprises selecting the second scale factor to position the visual focal point of the reproduction at a selected portion of the reproduction.

In another embodiment, the reproduction includes a three dimensional representation of a consumer product and has a visual focal point and the method further comprises selecting the second scale factor to position the visual focal point of the reproduction at the focal point of the consumer product.

In another embodiment, the second scale factor is a constant.

In another embodiment, the second scale factor varies at different positions in the work image.

In another embodiment, the object is a person and a first value for the second scale factor is used for at least one of the person's lips and eyebrows and a second value for the second scale factor is used for the person's nose.

In another embodiment, the reproduction is larger than the object and the second scale factor is in the range from 0.9 to 0.1 times the first scale factor.

In another embodiment, the reproduction is smaller than the object and the second scale factor is in the range from 2 to 1,500 times the first scale factor.

In another embodiment, the reproduction is smaller than the object and the second scale factor is in the range from 15 to 200 times the first scale factor.

In another embodiment, the object bears a two-dimensional image and the method further comprises producing the work image from the two dimensional image.

In another embodiment, the object comprises a photograph or sketch of an object and the method further comprises producing the work image from the photograph or sketch.

In another embodiment, the object comprises an artwork having a textured surface, the textured surface having multiple depths in the Z dimension, and the method further comprises producing the work image from the artwork.

In another embodiment, the object is three dimensional including a Z dimension having a plurality of depths and the method further comprises producing the work image from the object by, steps comprising providing lighting at a particular angle and/or from a particular direction to the object to create resulting shadows, altering the angle and/or direction of lighting of the object as a series of images are taken and interpreting the resulting shadows from the series of images to produce a map of the plurality of depths of the object in the Z dimension.

In another embodiment, the object is three dimensional including a Z dimension having a plurality of depths and the method further comprises producing the work image from the object by steps comprising taking a series of images of the object, wherein each image has a particular focal point or depth of field, altering the focal point and/or depth of field as the series of images is taken, and interpreting the resulting shadows from the series of images to produce a map of the plurality of depths of the object in the Z dimension.

In another embodiment, the object comprises a particular element having an identity and the method further comprises determining the first scale factor based on the X and Y dimensions of the substrate and at least one of the X and Y dimensions of the object and the X and Y dimensions of the representation of the object and selecting the second scale factor based on the identity of the element.

In another embodiment, the identity of the element comprises one of a car, a bottle, a full body image of a person, an image of a head of a person and a tree and the method further comprises providing a predetermined relationship between the first and second scale factors for at least some of the elements and utilizing the relationship when the reproduction is prepared.

In another embodiment, the object comprises two elements and the method further comprises providing a predetermined relationship between the first and second scale factors for the two elements and utilizing each relationship when the reproduction is prepared.

In another embodiment, the work image is produced at a first location and stored in a computer readable file and the computer readable file is sent to a second location where the reproduction is produced.

In another embodiment, the second location is physically remote from the first location and the computer readable file is sent via a data transmission network. Preferably, the reproduction is subsequently shipped to a customer.

In another embodiment, the reproduction is prepared by using scaled XY data to size the substrate and treating the substrate using the scaled Z data to produce the reproduction in three-dimensional form. Preferably, a plurality of depths in the Z dimension of the substrate are created by a variable mechanical force that is applied to the substrate. Preferably, a dot matrix printing head, a daisy wheel printing head, a matrix of pins or an electric deformable LCD is used to produce the variable mechanical force. Preferably, the mechanical force that is applied to a particular portion of the substrate corresponds to a plurality of depths in the Z dimension of that particular portion in the reproduction.

In another embodiment, the mold is prepared by machining, laser cutting, CNC machining, CNC laser cutting, fused deposition modeling, stereolithography and/or casting.

In another embodiment, the mold travels relative to a heater, the mold has a plurality of zones and the method further comprises independently adjusting the temperature of at least some of the zones whereby all portions of the substrate are subjected to generally uniform heating in the mold.

In another embodiment, at least some of the zones are configured to be cooled and the method further comprises providing different amounts of cooling to at least some of the zones.

In another embodiment, the substrate is porous and the method further comprises associating a non-porous layer with the porous substrate during the molding operation.

In another embodiment, the substrate comprises a frame member and the method comprises preparing a frame.

In another embodiment, the work image includes a design for a frame and the method further comprises integrally forming the frame as part of the reproduction.

In another embodiment, the method further comprises applying at least one texturing material to at least a portion of the substrate.

In another embodiment, the method further comprises selecting the texturing materials from at least one of, metal foil, metal particles, cloth, leather, ground clear glass, fragmented clear glass, ground coloured glass, fragmented coloured glass, clear silicone, coloured silicone, wood particles and a binder, and stone particles and a binder.

In another embodiment, the work image is used to prepare a negative image of the object on a substrate. Preferably, the substrate has a front face, and the substrate is configured to be generally concave when viewed from the front.

In another embodiment, the object comprises an artwork and the method further comprises:
(a) having a person apply enhancements to the artwork using a painting implement;
(b) capturing digital data representing at least one of the movements of the person, the movements of the painting implement and the colour of the paint applied to prepare the enhancements; and,
(c) mechanically applying at least some of the enhancements produced by the movements to the reproduction.

In another embodiment, the method further comprises manipulating the captured digital data to produce one or more files containing alternative subsets of enhancements; and, mechanically applying at least one of the subsets to the reproduction.

In another embodiment, the method further comprises using a robot to mechanically apply at least some of the enhancements produced by the movements to the reproduction.

In another embodiment, one of the scale factors is one.

In another embodiment, the method further comprises treating the substrate to temporarily reducing the rigidity of the substrate during the preparation of the reproduction.

In another embodiment, the method further comprises increasing the temperature of the substrate and/or chemically treating the substrate to reduce the rigidity of the substrate.

In another embodiment, the substrate comprises a thin sheet and the method further comprises applying an image of the object to the substrate.

In another embodiment, the scaled Z data is used to apply a relief pattern to the substrate and the method further comprises using the scaled X and Y data to apply the image of the object to the substrate prior to forming the relief pattern to the substrate thereby producing the three dimensional reproduction.

In accordance with another embodiment of the instant invention, there is provided a method comprising:
(a) providing an image on a front face of an image substrate;
(b) mounting the image substrate on a mounting substrate to produce a composite product; and,
(c) forming a three dimensional profile in the composite product.

In one embodiment, the method further comprises selecting a plastic as the mounting substrate and a cellulose based material as the image substrate.

In another embodiment, the method further comprises selecting a clear plastic as the image substrate and the mounting substrate is positioned over front face.

In another embodiment, the image substrate has a rear face and the method further comprises mounting a second mounting substrate to the rear face of the image substrate prior to forming a three dimensional profile in the composite product.

In another embodiment, the method further comprises applying steam to the image substrate after it has been mounted on the mounting substrate, applying heat to the mounting substrate and applying pressure to the composite product to form a three dimensional profile in the composite product.

In another embodiment, the method further comprises exposing the mounting substrate to infrared radiation to heat the mounting substrate.

In another embodiment, the method further comprises providing a weakened portion of the mounting substrate whereby the mounting substrate may bend along the weakened portion without breaking.

In another embodiment, the weakened portion comprises a score line.

In another embodiment, the method further comprises providing a picture or artistic work as the image.

In accordance with another embodiment of the instant invention, there is provided a method comprising:
(a) providing a porous image substrate;
(b) applying steam to the porous image substrate; and,
(c) associating a non-porous layer with the porous image substrate during a molding operation whereby a three dimensional profile is formed in the image substrate.

In one embodiment, the method further comprises printing an image on a front face of the image substrate prior to forming the three dimensional profile in the image substrate.

In another embodiment, the method further comprises disassociating the non-porous layer and the porous image substrate after the three dimensional profile has been formed in the image substrate.

In another embodiment, the method further comprises filling at least a portion of the profile formed in a rear face of the image substrate.

In another embodiment, the method further comprises selecting a plastic as the non-porous layer and a cellulose-based material as the image substrate.

An advantage of the instant invention is that by separately controlling the topography or the depth of the object in the Z dimension, separately from the length and width of the object, enlarged or reduced reproductions of an object may be prepared that are realistic. Another advantage of the instant invention is that by using different scaling factors, three-dimensional reproductions may be obtained which are suitable for various purposes, such as advertising, preparation of distributable consumer products, surface treatments for consumer products, and product packaging wherein the three-dimensional reproduction is provided with the topography which is perceptible by a user and is mechanically stable.

### BRIEF DESCRIPTION OF THE DRAWINGS

These and other advantages of the instant invention will be more fully explained and understood in conjunction with the following description of the preferred embodiments of the invention in which:

FIG. 1 is a perspective view of a substrate having a holographic appearance;

FIG. 2 is a top plan view of the substrate of FIG. 1;

FIG. 3 is a perspective view of a three-dimensional image and a reproduction of the three-dimensional image on a reduced scale;

FIG. 4 is a cross-section along the lines 4-4 in FIG. 3;

FIG. 5 is a cross-section of the line 5-5 in FIG. 3;

FIG. 6 is a schematic drawing showing a method of utilizing a computer capture data on the topography of a work of art or other picture;

FIG. 7 is a schematic drawing of a method of obtaining a work file containing three-dimensional data of an object wherein the image is captured digitally and utilized by a computer to obtain the work image of a three-dimensional object;

FIG. 8 is a schematic drawing of a method which may be utilized in accordance with one embodiment of this invention;

FIG. 9 is a top plan view of a three-dimensional reproduction prepared in accordance with the instant invention and a cross-section along the line 9-9 showing the topography of the three-dimensional reproduction;

FIG. 10 is a top plan view of a three-dimensional reproduction prepared in accordance with the instant invention and a cross-section along the line 8-8 showing the topography of the three-dimensional reproduction;

FIG. 11 is a top plan view of a three-dimensional reproduction prepared in accordance with the instant invention;

FIG. 11A is a cross-section along the line 11-11 in FIG. 11;

FIG. 12 is a stylized perspective view of a mold being CNC machined and drilled in accordance with a preferred embodiment of the instant invention;

FIG. 13 is a cross-sectional perspective view of the mold of FIG. 10 which shows the holes drilled therethrough;

FIG. 14 is a schematic representation of a method of manufacturing a three-dimensional reproduction according to one embodiment of the instant invention wherein the substrate is heated prior to insertion in a pressure molding station;

FIG. 15 shows a subsequent step in the method of FIG. 14 wherein the substrate has been inserted in the pressure molding station;

FIGS. 16 and 17 show an alternate embodiment of a method of manufacturing a three-dimensional reproduction according another embodiment of the instant invention wherein vacuum and pressure forming are utilized;

FIGS. 18 and 19 show a further alternate embodiment of a method of manufacturing a three-dimensional reproduction according another embodiment of the instant invention wherein vacuum forming is used;

FIG. 20 is a perspective view of a mold and cooling plate which may be used in accordance with any aspect of the instant invention;

FIG. 21 is an enlargement of a portion of the cooling plate of FIG. 18;

FIG. 22 is a cross-section through a mold station showing the use of the air cooled mode cooling system of FIGS. 20 and 21;

FIG. 23 is a perspective view of a liquid cooled mold cooling system which may be used with any aspect of the instant invention to obtain a uniform temperature across a mold;

FIG. 24 is a cross-sectional view through a molding station of the liquid cooled mold cooling system of FIG. 23 in use;

FIG. 25 is a perspective view of a substrate having enhancements provided thereon;

FIGS. 26A-26D shows a perspective view of a method of applying the enhancements of FIG. 23;

FIGS. 27A and 27B show side views of the method of FIGS. 26A-26D;

FIG. 28 shows a cross-section through a molding station of a mold being used to apply a topography to substrate having enhancements thereon;

FIG. 29 is a stylistic representation of a relief pattern being applied to a substrate using a print head incorporating a plurality of individually moveable pins;

FIG. 30 is an alternate method to the method of FIG. 29 wherein a rotatable die member is utilized;

FIG. 31 is an exploded view of a three-dimensional reproduction in accordance with one embodiment of the instant invention wherein the three-dimensional reproduction comprises a plastic sheet which is laminated over a mounting substrate, which is preferably paper, wherein the image is provided on the mounting substrate and the three-dimensional topography is formed in each of the overlying plastic sheet and the mounting substrate;

FIG. 32 is a side view of FIG. 31;

FIG. 33 is an alternate embodiment of a three-dimensional representation wherein a plastic sheet is provided on top of and behind the mounting substrate; and,

FIG. 34 is a side view of FIG. 33.

### THE DESCRIPTION OF THE PREFERRED EMBODIMENTS

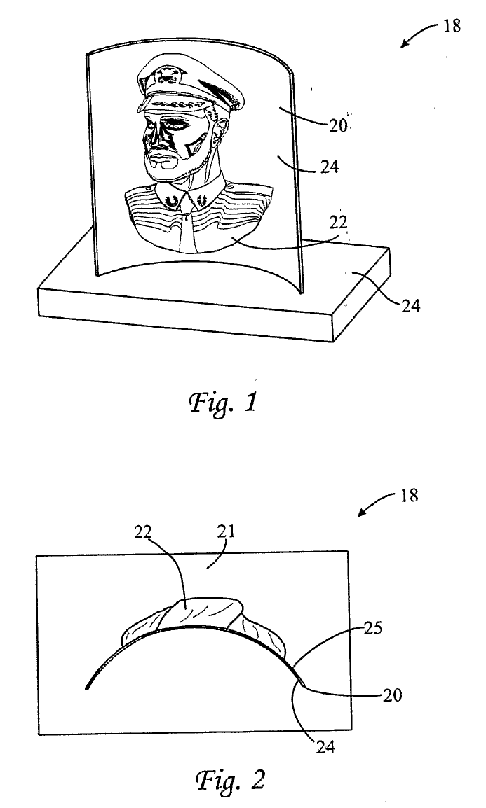

FIGS. 1 and 2 exemplify a preferred embodiment of the instant invention. As shown therein, a three dimensional reproduction 18 comprises a substrate 20 mounted on a base 21. Substrate 20 has an image bearing face displaying a picture 22, and a rear face 25. Face 21 may be any base suitable for receiving substrate 20 and, is optional. Face 21 may be a decorative member to assist in displaying substrate 20 or may provide a stable platform to which substrate 20 is affixed.

As shown particularly in FIG. 2, when viewed from the front, substrate 20 is concave. Accordingly, image bearing surface 24 is concave. Preferably, image bearing face 24 contains a negative image or reverse image. Accordingly, if substrate 20 were a planer (i.e. at extended in a two dimensional plane), then picture 22 would appear to have the reverse topography of the original from which it was made. However, in accordance with this aspect of the instant invention, substrate 20 is concave. Accordingly, as shown in FIG. 1, picture 22 has the illusion of appearing to be a positive image (i.e. having the same topography as an original from which it was made.

In accordance with a particularly preferred embodiment of this aspect of the invention, picture 22 is a picture of at least 1 person. For example, picture 22 may be a portrait of a person or of a family, or of a family pet. Alternately, it would be appreciated that picture 22 may be any graphic or artistic work, or a three dimensional representation of architecture, plants, trees or other wildlife.

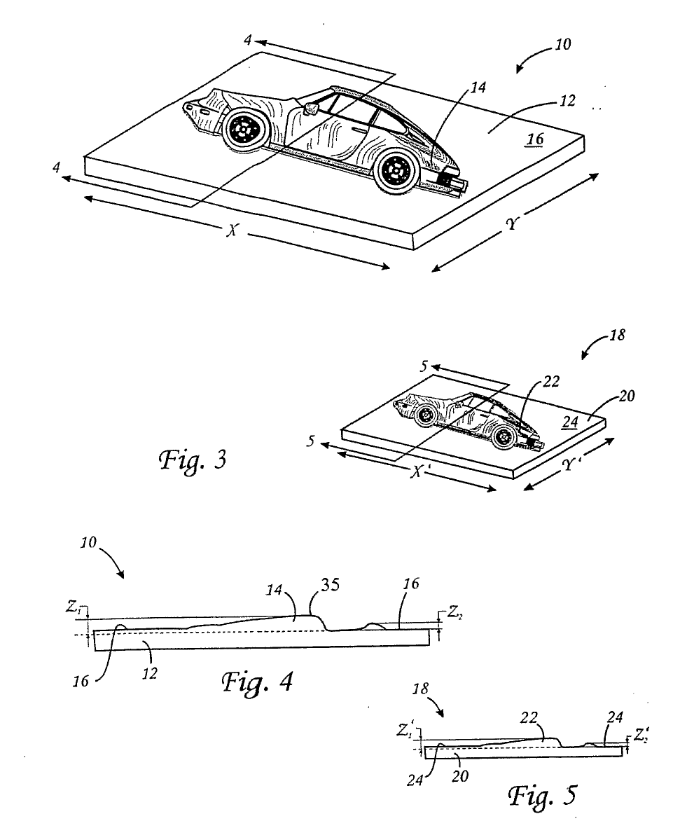

Picture 22 may be of the same scale as the original from which it is copied. Alternately, as exemplified in FIGS. 3-5, picture 22 having three-dimensional relief is reproduced on a different scale then a starting picture. In this example, the picture is reproduced on a smaller scale. It will be appreciated that the picture could alternately be enlarged.

As shown in FIG. 3, the “original” picture or object 10 has a length X and a width Y. Object 10 is formed on a substrate 12 and includes a picture 14 of a car. Substrate 12 has a front or image bearing face 16. Image bearing face 16 is essentially planar (i.e., it extends in a two-dimensional plane) except for the relief pattern associated with picture 14. In particular, as shown in FIG. 4, picture 14 has a plurality of depths in the Z dimension. For example, the maximum depth along the line 2-2 is represented by Z₁. At another portion, the picture 14 has a depth Z₂, which is smaller than Z₁. Therefore, the substrate contains a 3D version of the image.

It will be appreciated that an original object need not have straight sides and may therefore have a plurality of lengths and widths if measured at different portions of the object. For example, the object 10 could be an oval oil painting. In order to provide an accurate reproduction in the XY dimensions, the scale factor used for each X dimension is the same and the scale factor used for each Y dimension is the same. For ease of reference, the X data refers to all dimensions in the X axis and the Y data refers to each dimension in the Y axis and the Z data refer to each dimension in the Z axis. If all portions of the length are to be scaled by the same scale factor, then for ease of reference, the maximum length can be simply referred to as the “length” and the scale factor may be selected based on the desired “length” of the reproduction. Similarly, the maximum width can be referred to as the “width”

FIG. 3 also shows a three-dimensional reproduction 18, which is formed on substrate 20 having a three-dimensional picture 22 formed on image bearing face 24 of substrate 20. Once again, the three-dimensional reproduction 18 has a maximum height Z₁′ (see FIG. 5). At an alternate location, picture 22 has a maximum height Z₂′ which is smaller than Z₁′. Accordingly, both the original object 12 and the three-dimensional reproduction 18 have a relief pattern and, accordingly, are three-dimensional. In preparing the reproduction, it will be appreciative that both the length and width of the object 10 are reduced. Accordingly, the length X is reduced to obtain length X′. Similarly width Y is reduced to obtain width Y′. Accordingly, the length is reduced by a first scale factor based upon the ratio of X′:X. In a particular preferred embodiment, the width Y is varied by the same scale factor, i.e. the ratio Y′:Y is the same as the ratio X′:X. Accordingly, the ratio of the length and width of reproduction 18 is proportional to the ratio of the length and width of object 10. The object 10 has a plurality of depths in the Z dimension and include Z₁ and Z₂. The plurality of depths in the Z dimension are varied by a second scale factor to obtain the topography or relief pattern 35 shown in FIG. 3, which includes Z₁′ and Z₂′. In accordance with one embodiment of the instant invention, the second scale factor is different from the first scale factor. Accordingly, the topography of the reproduction is controlled separately from the sizing of the reproduction 18.

In the embodiment exemplified in FIG. 3, the reproduction 18 is smaller than object 10. Accordingly, the scale factor X′:X is less than one. Preferably, if the reproduction 18 is smaller than object 10, the second scale factor, namely the scale factor Z′:Z is 2 to 500 times the first scale factor and, preferably, from 15 to 200 times the first scale factor. For example, in the example of FIG. 3, if X were 3 and X′ were 1, then the scale factor X′:X would be ⅓, namely that the length of the reproduction is ⅓ the length of the original 10. In such a case, if the depths of the relief in the Z dimension were varied by the same scale factor, then the relief would be substantially less noticeable to a person. Accordingly, it is preferred to vary the second scale factor by less than the first scale factor. Accordingly, the relief would not be reduced proportionately with the length.

In an alternate embodiment, the reproduction 18 may in fact be an enlargement. In such a case, the scale factor X′:X would be greater than 1. In such a case, it may be preferable for the topography of surface 24 to be scaled to a lesser degree. For example, the second scale factor may be from 0.99-0.01 times the first scale factor. Accordingly, if the reproduction 18 is increased in size ten fold (such as in the case of a poster) it may be desirable to alter the depth of the topography on surface 24 by, for example, only twice the topography of the original (i.e., the second scale factor is 0.4 times the first scale factor). Preferably, this scale factor is selected such that the surface topography maintains a visual and tactile resemblance to the original and, more preferably the surface topography is enlarged up to 10× and most preferably up to 3×.

The second scale factor is preferably adjusted so that the texture on surface 24 is perceptible to a person. This is particularly so if reproduction 18 is reduced in size. Further, it will also be appreciated that if a reproduction 18 is an enlargement or is smaller in size than original 10, that the second scale factor is preferably selected so that reproduction 18 has a realistic appearing texture. Accordingly, as the first scale factor is increased, the second scale factor is preferably selected so that the depth of the texture is not increased proportionately the same amount, but is increased at a lesser rate. Similarly, if reproduction 18 is reduced in size (i.e., the first scale factor is less than 1) then it is preferred that the depth of the texture of reproduction 18 is reduced at a lesser rate or, in an alternate embodiment, may be kept the same (i.e. the second scale factor is 1).

If the second scale factor is varied by the same amount as the first scale factor, this may result in reproduction 18 having an overall appearance that it's texture has been scaled by a different amount. For example, scaling the texture by the same amount as the length and width of an object when the reproduction is, for example, for use in a billboard, may result in a reproduction where the depth of the topography appears to be exaggerated. Accordingly, the second scale factor is preferably selected so that the depth of the topography of reproduction 18 appears natural and, accordingly appears to have been scaled by the same scale factor as the first scale factor. Also, using the same scale factor may result in the portions of the reproduction having the maximum relief structurally weak and liable to be damaged by weathering.

In a particular preferred embodiment, the width of an object in the Y axis is preferably scaled at the same amount as the length in the X axis. Accordingly, the scale factor Y′:Y is preferably the same as a scale factor X′:X. Accordingly, the length and width of an object are proportionately reduced. It will be appreciated that, in some cases, the length and width of an object may be reduced by varying amounts, such as to create visual effects for seasonal events such as Halloween or for humerous illustration. In such a case, the third scale factor Y′:Y may be 80-120% of the first scale factor. Accordingly, in the example of FIG. 3, if the first scale factor X′:X is ⅓, then the third scale factor Y′:Y may be from 0.27-0.4.

In order to prepare the reproduction, a work image of object 10, which includes a three dimensional representation of object 10, is obtained. The work file may be obtained in advance and stored until required or it may be created and used at the same time. The work image may be prepared at one location and delivered to another location such as by e-mailing an electronic file or sending a CD or a flash drive containing the work file.

Original 10 may comprise an original work of art, an actual object (e.g., an article of manufacture such as a car), a picture or other two dimensional image (e.g. a photograph or a sketch). In either case, a work image of object 10 which includes a three dimensional representation of object 10 may be obtained. The three dimensional representation of object 10 has a length in each of the X and Y dimensions and a plurality of depths in the Z dimension. If the object 10 has a topography, then the topography may be detected by a suitable scanner or other device and this data may be included in the electronic data defining the work image. Alternately, object 10 may be a picture. In such a case, the topography or texture of the subject depicted in the picture may be determined by any means known in the art, such as by scanning the image and using computer algorithms to develop a three dimensional topographical map of the elements contained in the picture.

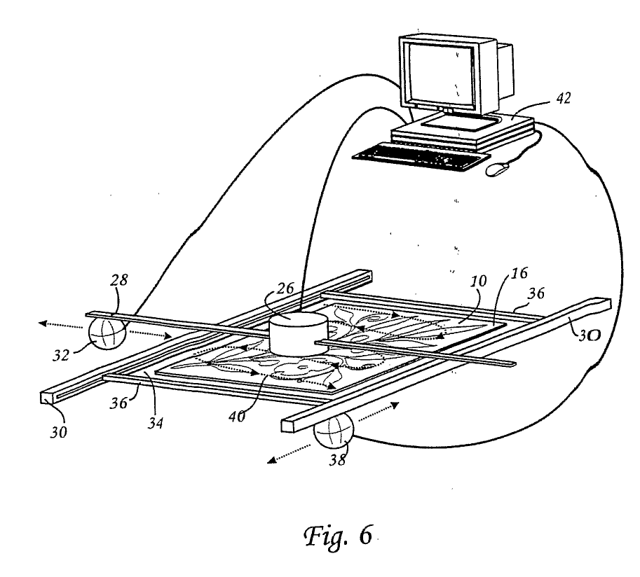

For example, referring to FIG. 6, object 10 may be placed face up on a surface, or alternately may be held in position on a frame. A scanning head 26 is movably mounted over object 10, such as by means of movable frame members 28 and 30. As exemplified in FIG. 6, scanning head 26 is fixedly mounted to frame 28 and frame 28 is movably mounted with respect to object 10, such as by a motor 32. Motor 32 may be configured to move member 28 laterally. Object 10 may be supported on a bed 34, which is held in position by fixed frames 36. Frame members 30 are movably mounted longitudinally with respect to fixed frame 34, such as by motor 38. Accordingly, scanning head may be able to be moved in a grid pattern represented by dashed arrow 40 across image bearing face 16 of object 10. Alternately, scanning head 26 may be moved in any pattern.

Computer 42 may be connected to motors 32 and 38 and send signals to the motors to cause them to move scanning head 26. Computer 42 may optionally receive feedback from motors 32, 38, or from other auxiliary sensors (not shown) to confirm the location of scanning head 26. Accordingly, the depth of a topography at any particular location can be precisely matched with the position of scanning head in the XY plane. In an alternate embodiment, it would be appreciated that scanning heading 26 may be held in a fixed position and object 10 could be moved relative to scanning head 26. Alternately, both object 10 and scanning head 26 could be in motion at the same time.

If object 10 has a topography, then scanning head determines the depth at a given location of the topography of object 10 by any means known in the art, such as ultrasound, lazar reflection, optical/photographic scanning techniques, mechanical probing or the like. This data is transmitted to computer 42 where a three dimensional topographical map of the artwork is created. This three dimensional topographical map (the work image) may comprise electronic data representing the coordinates of each element in the X, Y and Z axis. A conventional coordinate measuring machine could alternately be used to create such a topographical map and stored in memory, which is computer or machine readable. If object 10 is a two dimensional picture then scanning head 26 might use interpolation based on shadows present in the image, interpolation based on shadows present or created by specialized lighting of the object from specific distances and angles, ultrasonic or higher frequency reflection/absorption topography mapping techniques, or any other technique known in the art to obtain data representing the there dimensional topography of the elements shown in object 10.

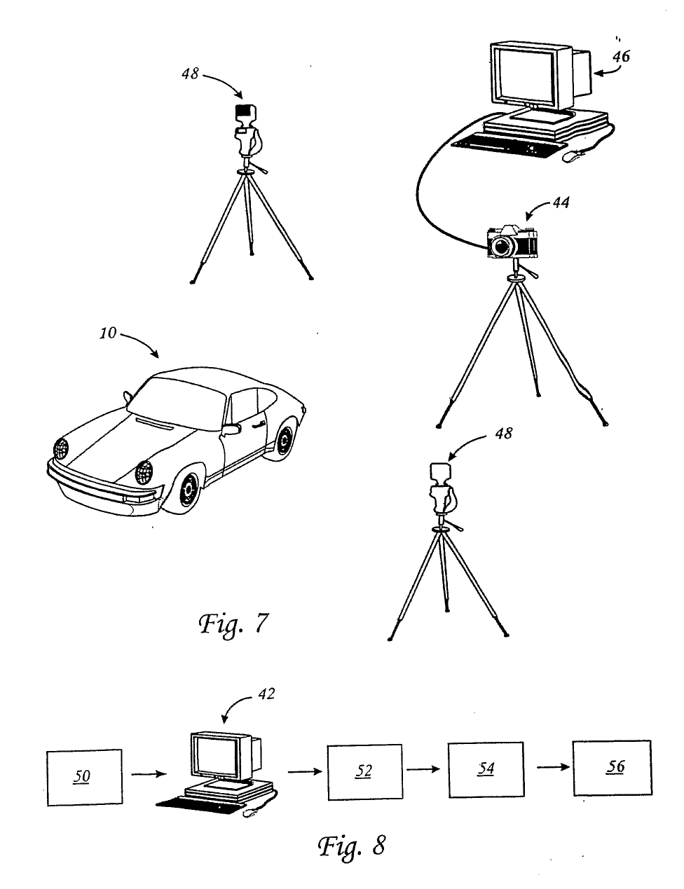

In an alternate embodiment, object 10 may be a three dimensional object. For example, as shown in FIG. 7, object 10 is a car. Alternately, the object could be a person. A work file may be obtained of object 10 by any means known in the art. For example, as shown in FIG. 7, camera 44 may be used to take a series of pictures of object 10. The pictures may be captured on film and subsequently digitized and provided to a computer. Alternately, camera 44 may take a plurality of digital pictures, which are downloaded to computer 46. In one embodiment, one or more lights 48 are provided. A series of pictures may be taken from different directions while the angel and/or direction of the light provided from lights 48 is varied wherein, in different images or pictures, different shadows are created. Computer 46 may use a suitable algorithm to interpret the resulting shadows to produce a map of the plurality of depths of the object 10 in the Z dimension. An alternate method that could be used includes taking a series of pictured or images of object 10 wherein each picture or object has a particular focal point or depth of field and the focal point and/or depth of field are altered as a series of images of pictures are taken. In such a case, computer 46 could use an appropriate algorithm to interpret the resulting shadows from the series of images or pictures and produce a map of the plurality of depths object 10 and the Z dimension. Radar or any of a wide range of frequency bands of electromagnetic energy could alternately be used.

Once the digital data is obtained, it may be stored in memory and subsequently manipulated to produce the scaled XYZ data. For example, as shown in FIG. 8, the digital data may be stored electronically in data storage unit 50. Data storage 50 may be a memory card for a camera, a hard drive of a computer, a zip drive, a CD or the like. Data storage unit 50 contains electronic data representing a work image of object 10 and includes data on the X, Y and Z dimensions of object 10. Accordingly; the data will represent at least one dimension in each of the X and Y axis and at least two lengths in the Z axis and, preferably represents at least one dimension in each of the X and Y axis and a plurality of depths in the Z axis. It will be appreciated that the data may, such as in the case of an object such as a car, have a plurality of data points in the X, Y and Z axis. This data may be provided to a computer or other calculating device 42 to produce scaled XY data 52 and scaled Z data 54 which is then stored in data storage unit 56 for later use and/or used immediately.

In one embodiment, the method may comprise processing the electronic data in data storage unit 50 with a first scale factor for scaling the length of at least one of the X and Y dimensions of the three dimensional representation of object 10 (and preferably both) to provide a first scaled data set having scaled X and Y data and original Z data and, subsequently processing the first scale data set with a second scale factor for scaling the plurality of depths in the Z dimension of the three dimensional representation of the object to provide a second scaled data set which may then be stored in second data storage unit 56.

Alternately, the method may comprise processing the electronic data stored in data storage unit 50 with a first scale factor for scaling the length of at least one of the X and Y dimensions of the three dimensional representation of object 10 (and preferably both) to provide scaled XY data and processing the electronic data by applying a rule based upon the first scaling factor, wherein the rule represents a second scale factor, to obtain the scaled Z data wherein the scaled X, Y, and Z data is then stored in second storage unit 56. For example, the extent to which the Z dimension is scaled may be varied based upon a preset algorithm based upon the extent to which the X dimension is scaled.

Alternately, computer 42 may include an element recognition algorithm and may be programmed with a series of rules whereby a particular element or series of elements are scaled according to a preset or predetermined second scale factor. For example, object 10 may comprise a particular element having an identity (e.g. a car in the case of FIG. 7) and the second scale factor may be selected based upon the particular element being a car. It will be appreciated that the selection of the second scale factor based upon the identity of one or more elements in object 10 may be automated or may be manual (i.e., the recognition of the element may be by an operator of the system and the operator may select the second scale factor based upon a set predetermined rules). For example, the element may be a car, a bottle, a full body image of a person, an image of a head of a person, a tree and a predetermined relationship may be predetermined between the first and second scale factors for at least some, and preferably each, of the forgoing elements. If an object comprises two or more elements and each element has a predetermined relationship between the first and second scale factors which are to be used, then the first element may be reproduced using the predetermined relationship between the first and second scale factor to be used for that particular element and the second element may be scaled using a predetermined relationship between the first and second scale factors for the second element.

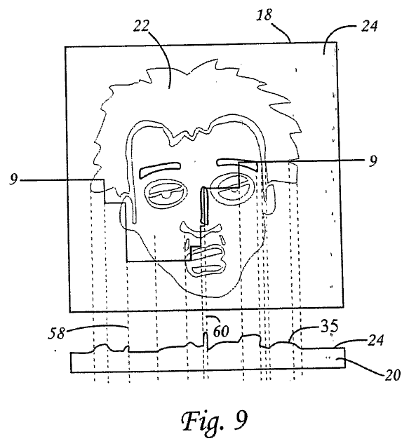

For example, this technique could be used when producing a reproduction of a face. FIG. 9 shows a top plan view of a reproduction 18 bearing a picture 22 of a face. FIG. 9 also contains a cross section along the line 9-9. The cross section passes through various features of a person including the hair, and ear, the mouth, the nose, the eye and eyebrow of a person. The cross section is oriented in FIG. 9 so that different portions of the top plan view are correlated with the topography as shown in cross section. For example, dashed line 58 shows the elevation of the ear of the face whereas dashed line 60 shows the elevation of the nose. Accordingly, in accordance with one embodiment of the invention, each portion of the face could be scaled in the Z dimension the same amount. Alternately, different portions of a person's face could be scaled by varying amounts. For example, if a picture were to be reduced in size 5 fold (the first scale factor is 0.2), and the second scale factor were constant, then the topography in reproduction 18 may result in some features of the face being essentially flat (i.e. having no detectable topography to a viewer). For example, the lips and eyebrows may appear to be flush with the skin of the face. Accordingly, in accordance with one preferred embodiment of this invention, a first value of the scale factor may be used for features of a face which have a small variation in height (e.g. at least one of the lips, eye brows, jaw bone) and the second value of the scale factor may be used for features of the face which have more pronounced variation in height (e.g. a nose, chin, ears, cheek bones). Thus, a first value of the second scale factor could be used, which will result in a perceptible topography in reproduction 18 for the lips and/or eyebrows and a second value of the second scale factor could be chosen so as to reduce the height of a persons nose at a rate greater than the reduction in the height of the persons lips and/or eyebrows. Accordingly, certain features of the face would be relative flattened while other features of the face would be relatively less flattened. Accordingly, a topography could be obtained which provides relief for each part of a face without the portions of the face that have a greater height (e.g. the nose) extending excessively above image bearing surface 24 of substrate 20. Similarly, if the object is enlarge, then different values of the second scale factor could be used so as to enlarge the height of a persons nose at a rate lesser than the enlargement in the height of the persons lips and/or eyebrows.

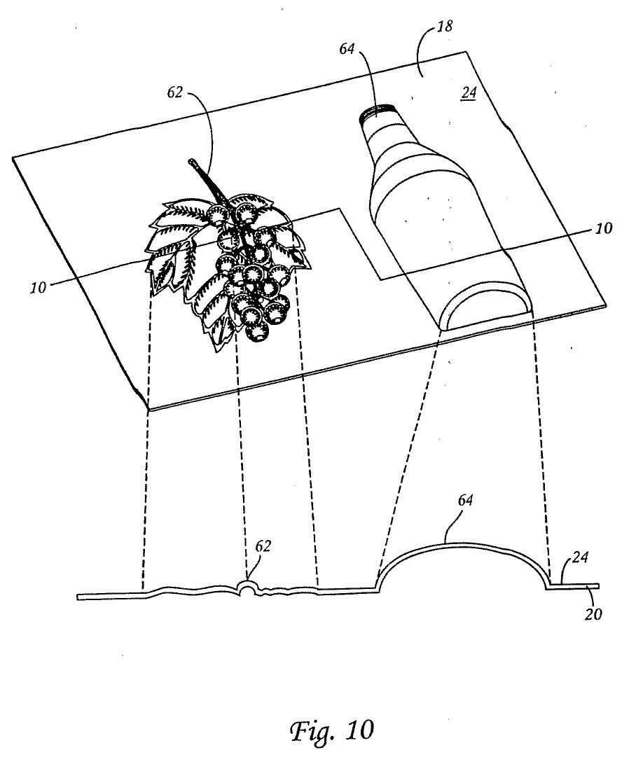

A further example of such an alternate embodiment is shown in FIG. 10. In FIG. 10, reproduction 18 contains a picture of grapes 62 and a picture of a bottle 64. As shown in the cross section 10-10 of FIG. 10, the grapes have a relatively muted topography (i.e., the maximal height of the topography above image bearing surface 24 is relatively small compared to the maximum height of bottle 64 above surface 24. Accordingly, the topography of bottle 64 is substantial more pronounced compared to that of grapes 62. In this example, if reproduction 18 is an enlargement, it would be appreciated that the value of the second scale factor used for grapes 62 was relatively small whereas the second scale factor that was used for bottle 64 was relatively larger. Alternately, in this example, if reproduction 18 is prepared on a reduced scale, then it would be appreciated that the value of the second scale factor used for grapes 62 would be substantially larger than the value of the second scale factor used for bottle 64.

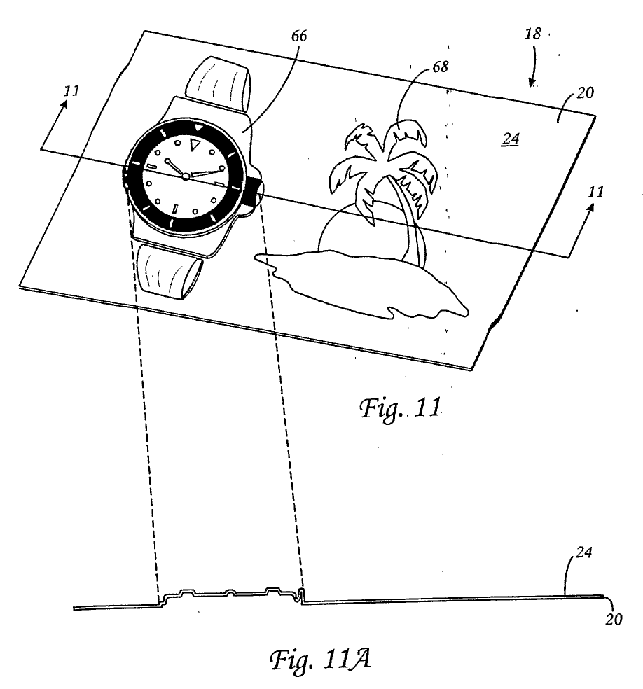

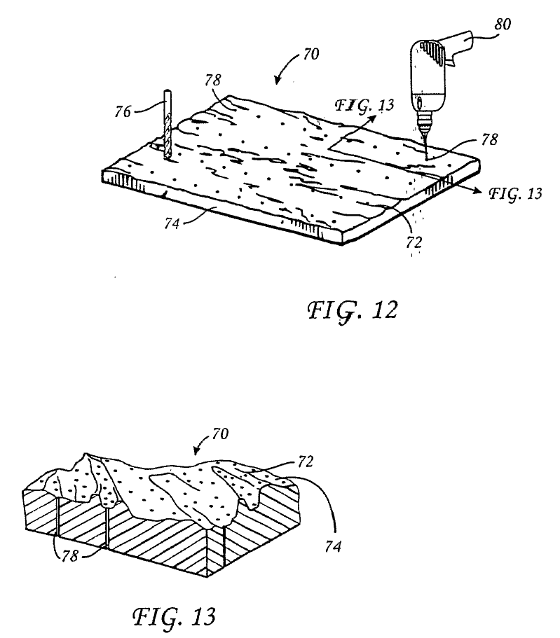

A further alternate embodiment is shown in FIGS. 11 and 11A. In this embodiment, reproduction 18 includes a picture of a watch 66 and a tree 68. In this particular embodiment, as shown in FIG. 11A, only the watch has a topography. Accordingly, it would be appreciated that different values of the scale fact were used for the watch 66 and the tree 68. In fact, the value of the scale factor, which was selected for tree 68, was selected so that tree 68 had a flat topography (it did not extend above surface 24 as shown in FIG. 11A). One advantage of this embodiment of the instant invention is that a three dimensional topographical relief could be provided at a position which is to be the visual focal point of reproduction 18, or could be enhanced at a position which is to be the visual focal point of reproduction. In this way, the selection of the second scale factor, or the use of a second scale factor for a portion of the visual elements in the reproduction, could be selected to draw a consumer's attention to a particular portion of a reproduction. Thus, in the example of FIG. 11, the reproduction could be an advertisement for a watch. By selecting the second scale factor to position the visual attention of a viewer on the watch (such as by enhancing the topography of a watch compared to the topography of the rest of reproduction 18) the visual focal point of the advertisement can be shifted to the watch, or could enhance the visual appearance of the watch, to thereby enhance the effect the advertisement has on a consumer.

A mold, which may be utilized to prepare reproductions according to any embodiment of the instant invention, may be prepared in accordance with any means known in the art. The mold may be made by an additive or a subtractive process. A subtractive method comprises removing material from a block, e.g., of metal. An additive method comprises building a mold such as by using rapid prototyping techniques. In one preferred embodiment, mold 70 is prepared from plaster, high temperature plastic, epoxy, aluminum or other metal so as to have a relief pattern 72 formed therein. Preferably, the mold is made from a material that has sufficient strength to enable the mold to be used at least about 100 times, preferably at least about 10,000 times and, most preferably, at least about 100,000 times without any significant deterioration in the topography in the resultant molded substrate. Mold 70 may be prepared by CNC machining relief pattern 72 into surface 74 by means of a cutter or a plurality of cutters 76. Alternate methods for manufacturing vacuum or pressure forming molds, such as laser cutting, fused deposition modeling, stereo lithography, 3D printing using a plaster or other powder substrate, or casting may be utilized.

For use in pressure and/or vacuum molding, a series of holes 78 may be formed by any means known in the art, such as a drill 80. Drill holes 78 are preferably drilled in the lower most portions or portions of relief pattern 72 and permit air to escape through the mold during pressure and/or vacuum forming operations.

It is particularly preferred that the mold is suitable for use in a molding operation, preferably vacuum and/or pressure forming, as opposed to an embossing operation. Typically, embossing dies have an aspect ratio of the height of a relief element in the embossing die to the width across the top of the relief element of not greater than 1:1. Accordingly, if an element in the relief provided in an embossing die has a height of 1 cm, then the width of the element in the embossing die is typically at least 1. Accordingly, the relief element has a width at least the same as, and generally greater than, the height of the relief element in the die. Such constructions are utilized as embossing dies are subjected to substantial wear and tear during operation and the relief pattern in an embossing die will quickly deteriorate if the width of an element is less than the height of an element. In contrast, in accordance with the instant invention, the width of a relief element in the die is preferably less than the height of the relief element. Accordingly, the die may produce a reproduction having finer detail than is available by embossing. Accordingly, the ratio of the width of an element to the height of the element in an embossing die is preferably less than 1.

Once the mold is prepared, the mold may then be used for creating one or more reproductions 18 using a continuous sheet of substrate or a plurality of individual sheets of substrate. The substrate may be any substrate capable of being molded. Preferably, the substrate is a thermo-formable plastic or cellulose based (e.g. paper, cardboard, or paper mache). The thermo-formable plastic is preferably poly vinyl chloride, polystyrene, neoprene, PET and, preferably, is PVC and, most preferably, is polystyrene. One advantage of the use of neoprene is that neoprene may be reversibly deformable and, accordingly, can be reused in the process. It will also be appreciated that the substrate may be an irreversibly deformable thermo-plastic such as poly vinyl chloride or polystyrene. In such a case, the thermo-formable plastic may be recycled by grinding the used substrate as is known in the art.

The thermo-formable plastic substrate may have a thickness from 0.002-0.02 inches, preferably from 0.005-0.015 inches, more preferably from 0.008-0.012 inches. Alternately, the substrate may be porous such as paper or cardboard. In such a case, the substrate is preferably from 0.002-0.025 inches thick, more preferably 0.005-0.02 inches and, most preferably 0.008-0.015 inches thick. A substrate is preferably considered to be porous if it will allow a flow of more then 0.1 cubic inches of gas per square inches of substrate per minute therethrough when a vacuum of 25 inches of mercury apply to the substrate.

In order to enhance the pressure/vacuum molding of a porous substrate, a coating is preferably applied to the porous substrate or a nonporous substrate provided to make the porous substrate essentially gas impermeable so that it can be vacuum formed and/or pressure formed. The coating may be a compound such as ethylene vinyl acetate, which is applied to the paper or, alternately, a gas impermeable layer such as a thermoformable plastic, vapor deposited silicon monoxide or dioxide, or a thermoset plastic and may have a thickness of 0.0002 to 0.010 inches, more preferably 0.005 to 0.005 inches, and most preferably 0.001 to 0.003 inches. The porous substrate is preferably in intimate contact with a gas impervious layer (e.g., an elastomeric material such neoprene) such that pressure and/or vacuum may be applied to the cellulose based substrate such that the substrate is forced into intimate contact with a mold, thereby causing the cellulose based substrate to take on the shape of the mold, which may be a three dimensional representation of an original piece of art. The nonporous sheet also takes on the configuration of the surface of the mold during the molding operation and provides structural strength to the porous substrate to assist in durability of the resultant reproduction. Alternately, the nonporous sheet may be removable from the porous sheet once the porous sheet has been molded. For instance, a neoprene sheet could be “electrostatically adhered” to the porous sheet and removed after the image has been formed.

It will be appreciated that if additional rigidity of the topography is required, that the rear surface of the molded substrate (i.e., the non image bearing surface) of the molded substrate, may be filled in with a casting material, such as plaster or the like.

Prior to applying a topography to the substrate, an image of the object is preferably first applied to the substrate. For example, the image may be applied by printing a two-dimensional image on the substrate by any means known in the art including one or more of offset lithography, silk screening, spray coating, ink jet printing, or dye sublimation printing. Subsequently, the substrate is subjected to the molding operation. The image printed on the substrate is preferably aligned with the topography of the mold by any means known in the art. For example, if the substrate is the same size as the mold, then by aligning the outer edges of the substrate with the mold, the image and the substrate may be aligned with the features of the topography that match the image.

The substrate may then be placed in a mold and pressure and/or vacuum applied so as to form a topography or relief pattern in the substrate. Prior to or during the molding operation, the substrate may be treated to reduce the rigidity of the substrate permitting the substrate to better conform to the topography of the mold without tearing or otherwise damaging the substrate. For example, the temperature of the substrate may be raised to permit the substrate to more easily flow into or be pressed into the topography of the mold. Alternately, one or more chemicals would be applied to the substrate to temporarily reduce the rigidity of the substrate. For example, polystyrene, poly vinyl chloride or ABS may be exposed to methyl ethyl ketone (MEK). The MEK results in the thermo-formable plastic temporarily softening thereby enhancing the molding operation. Alternately, if the substrate is cellulose based (e.g., paper or cardboard) the substrate may be exposed to steam prior to or during the molding process. It will be appreciated that an external heat source, such as electric heating coils, may be used in conjunction with steam to heat the cellulose based substrate and that the substrate may be exposed to water and then heated. Such treatments result in the substrate being able to bear finer detail and also enhance the lifetime of the molds that are utilized. Alternately, a cellulose base substrate could be coated with a polyester resin. The polyester resin will result in the cellulose based substrate being temporarily more pliable. During the molding operation, if heat is applied, the resin will cure. As the resin cures, the substrate hardens. Accordingly, the use of a polyester resin or the like will result in a molded substrate wherein the image is more durable. Alternately, cellulose binders such as corn starch could be utilized.

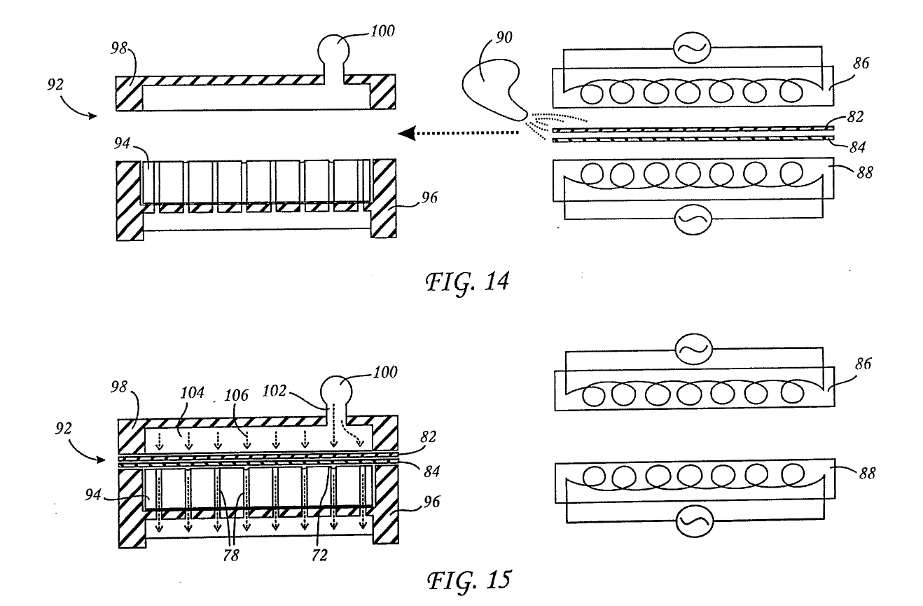

FIGS. 14 and 15 exemplify a method of molding a porous substrate. As shown therein, a sheet of pressure or vacuum deformable nonporous material, such as neoprene, 82, and a sheet of porous substrate 84 are preheated, such as being placed in a heating unit between electrical heating elements 86 and 88. A source of steam 90 is used to expose porous cellulose based substrate 84 to steam. For example, injection nozzles may be provided intermittently between heating elements 86, 88. Once porous substrate 84 is heated and softened by the steam, (e.g. for a preset time or to a predetermined temperature), porous substrate 84 together with deformable nonporous sheet 82 is transferred to a molding station 92. As shown in FIGS. 14 and 15, molding station 92 comprising a mold 94, which is positioned in support frame 96. An air pressure delivery vessel 98 (which may comprise a manifold) is an airflow communication where the pressure source 100 (which may be a pump). Once sheets 82, 84 are placed in molding station 92, pressure delivery vessel 98 is secured in position with respect to support frame 96 so as to create an airtight chamber above sheet 82. Pressure source 100 may then be actuated which forces air pressure down passage 102 the cavity 104 within the air pressure delivery vessel 98 thereby causing nonporous sheet 82 to press against porous substrate 84 thereby causing the porous substrate to take on the shape of relief pattern 72 of mold 94. As the air pressure in cavity 104 forces the porous substrate 84 to be deformed to the shape of relief pattern 72, air 106 which is positioned between substrate 84 and relief pattern 74 escapes through holes 78. In vacuum molding operations, the theoretical upper limit of vacuum of which can be provided is 15 psi. In contrast, the pressure that can be used in the process FIGS. 14 and 15 can be in excess of the 15 psi available from the atmosphere in vacuum molding operations. Accordingly, greater forces can be applied to substrate 84 then by means of a vacuum alone. Hence, greater detail in resolution can be achieved than with vacuum molding. Preferably, the pressure source 100 is activated until the nonporous substrate 82 has sufficiently cooled to enable substrate 82 to retain the deformed shape. Alternately, if a curable resin is applied to the porous substrate, the pressure source may be actuated until the resin has cured sufficiently to permit substrate 84 to be removed from the mold without essentially any damage to the topography formed in substrate 84. It will be appreciated that if a resin is applied, a nonporous substrate 82 may optionally not be used.

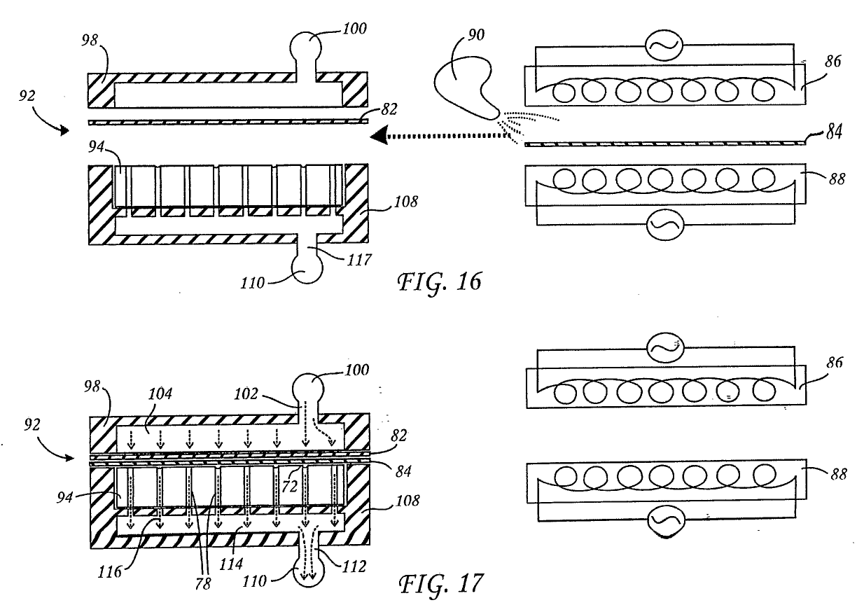

An alternate molding operation is shown in FIGS. 16 and 17. As shown therein, only porous substrate 84 is subjected to heating and steam treatment prior to insertion in molding station 92. Porous sheet 84 is transferred to molding station 92 at which time nonporous sheet 82 is provided thereover. A pressure molding operation as depicted in FIG. 16 may now proceed. Alternately, a pressure and vacuum forming operation may be conducted. Referring to FIG. 16, mold station 92 is provided with a vacuum delivery vessel 108, which is an airflow communication with a vacuum source 110 (e.g. a vacuum pump) such as by passage 112. During operation, in addition to the pressure that is applied via cavity 104, vacuum pump 110 draws air through pump cavity 114 via passage 112. Accordingly, vacuum source 110 is actuated so as to evacuate vacuum delivery vessel 108 thereby causing negative pressure in cavity 114 which draws air 116 through holes 78 thereby causing nonporous sheet 82 to apply force to the porous substrate 84 causing it to deform to the shape of the relief pattern 72. Once again, the pressure source 100 and the vacuum source 110 may be operated for a predetermined amount of time or otherwise is taught herein. As the pressure which could be used in this process can exceed the 15 psi available from the atmosphere when operating a vacuum molding process, greater force can be applied to the substrate and hence greater detail of resolution can be achieved then the vacuum molding alone. For example, by using a combination of vacuum and pressure molding, the effective force imparted to the substrate by the pressure and vacuum created by vacuum source 110 and pressure source 100 can exceed 29 to 30 inches of mercury.

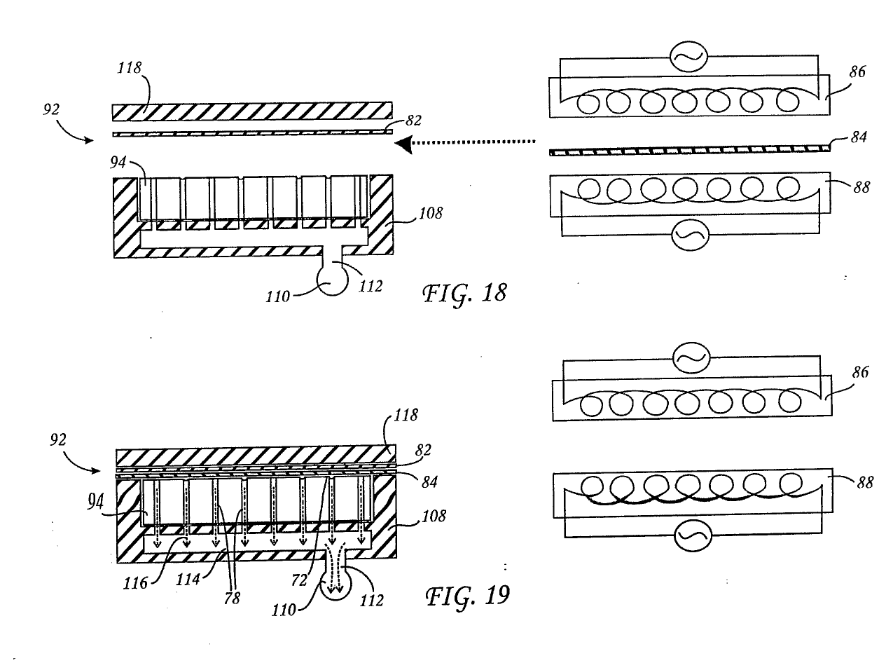

In accordance with a further manufacturing operation, it will be appreciated that substrate 84 may be subjected only to vacuum molding. Such a process is exemplified in FIGS. 18 and 19. As shown therein, porous substrate 84 is heated and then transferred to molding station 84 where a nonporous layer 82 is placed on top of substrate 84. The substrates 82, 84 are secured in the molding station by any means known in the art, such as by clamping member 118. The vacuum molding process may then proceed as known in the art.

It will be appreciated that in an alternate embodiment, different modifications and combinations of these molding techniques may be utilized. In addition, if the substrate is thermoformable, no steam needs to be provided during the heating operation. In addition, the substrate may not be preheated but may alternately be heated only in molding station 92. In addition, it will be appreciated that, if the substrate is porous, that a nonporous substrate or layer may be associated with the porous substrate prior to or subsequent to the insertion of the porous substrate into a molding station in 92. For example, the porous substrate (e.g. paper) could be laminated to a thin sheet of poly vinyl chloride or polystyrene prior to any pretreatment steps. Alternately, the thin sheet of poly vinyl chloride or polystyrene could become laminated to the porous substrate during the molding operation. The porous substrate could be mechanically mounted to the nonporous substrate due to the heat and pressure that the substrates are exposed to during any pretreatment step as well as during the molding operation. Alternately, an adhesive, which may be heat activated, could be applied between the porous substrate and the nonporous substrate so as to produce a laminated reproduction whereby the nonporous substrate is securely fixed to the porous substrate.

In accordance with another aspect of the instant invention, the temperature of the substrate in the mold is controlled so as to provide more uniform heating and/or cooling of the substrate. In order to produce an accurate molded reproductive, the substrate must be sufficiently pliable so as to confirm with the configuration in the surface of the mold. If the temperature is too low, then the substrate may not deform so as to come into full contact with all portions of the surface of the mold. Alternately, if the temperature is to high and the substrate is a thermoformable plastic, then the plastic will tend to flow to the lower depressions in the mold thereby resulting in a molded reproduction wherein the thickness of the substrate is uneven and may have holes therethrough. In order for the reproduction to also accurately mirror the topography in the surface of the mold, the rigidity of the substrate must increase after a pressure and/or vacuum molding operation prior to removing the substrate from the mold. According to this aspect of the invention, a vacuum and/or pressure molding operation is controlled so that each portion of a substrate is subjected to similar heating and/or cooling. Accordingly, all portions of the molded reproduction may be of the same, or essentially the same, quality. In particular, the quality of the substrate may be sufficiently uniform that so no deviation in the resolution of the topography is visible to a person.

Accordingly, in one embodiment, a series of cooling zones are incorporated into a mold such that the amount of cooling provided to each zone of the mold, and therefore the temperature of each zone of the mold, can be individually controlled. For example, in a vacuum molding operation, a heating element (e.g., an oven) may be provided. The vacuum mold may be passed underneath the heating element to heat the substrate while a vacuum is applied to the image surface of the substrate. For example, the oven may be stationary and the vacuum mold, with the substrate attached, may be placed underneath or into the oven by traveling in a first direction. The vacuum mold and substrate may be removed from the oven in the reverse direction from which the mold was inserted. Accordingly, the leading edge of the substrate which first enters the mold is subjected to heating for an additional amount of time. This additional amount of time, taking into account the thickness of the substrate, may be sufficient for the leading edge of the substrate to undergo excessive heating resulting in degradation of the molded substrate. Conversely, the trailing edge (the last portion of the substrate to enter the oven) may not be heated for sufficiently long to obtain full contact between the thermoplastic substrate and the mold. By providing different cooling zones in the mold, different temperature regions of the mold can be created in an axis oriented perpendicular to the movement of the vacuum mold thereby compensating for the differential heating which would otherwise be imparted to the substrate by the oven. It will be appreciated that, in an alternate embodiment, the vacuum mold may be stationary and the oven may be movable. Alternately, both the oven and the mold may be moveable relative to the other.

Alternately, or in addition, a series of heat shields, preferably aluminum heat shields, may be installed behind the heating elements of an oven to create more uniform heat distribution to the substrate during the heating process. Preferably, aluminum heat shields are utilized as this will result in the reduction of the radiant heat lost from the oven thereby allowing the electric heating elements to operate at a lower temperature, which will also aid in increasing the uniformity of heating and reducing the energy consumption of the operation.

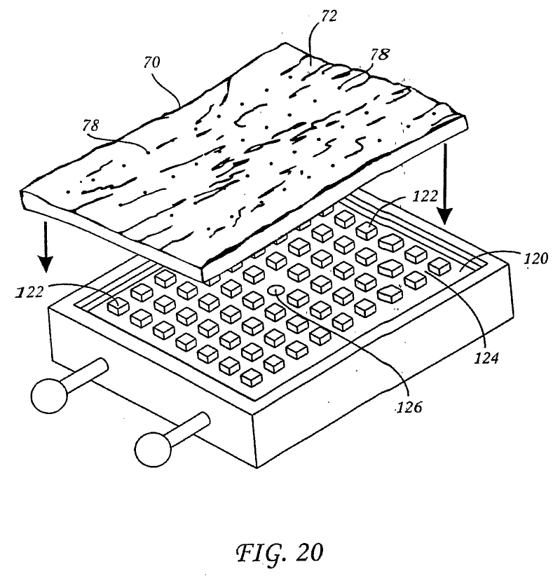

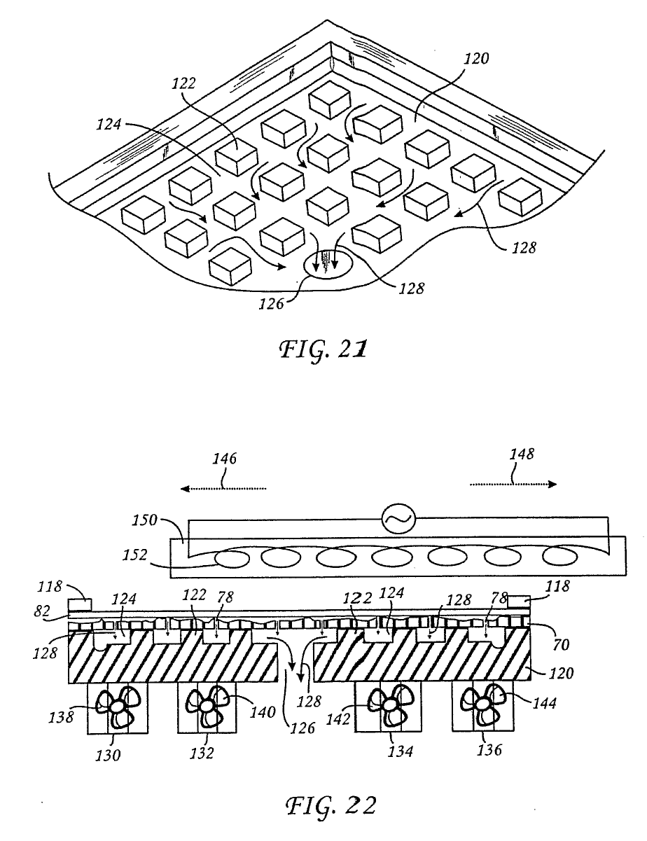

An example of a mold with different cooling zones is shown in FIGS. 20 and 21 wherein mold 70 is mounted on top of aluminum cooling plate 120. Aluminum cooling plate incorporates a series of thin posts 122 and a series of slots 124 which extend between thin posts 122. When mold 70, which may be made from an epoxy, metal, ceramic or other material known in the art is brought into contact with cooling plate 120, thin posts 122 contact the rear surface of mold 70 thereby serving to transfer heat from mold 70 to mold cooling plate 120. During vacuum and/or pressure molding, slots 124 serve as channels to allow air 128 to be drawn or forced through holes 78 of mold 70 and to exit cooling plate 120 through one or more end holes 126.

In order to provide differential cooling to different portions of cooling plate 170, a plurality of cooling fins 130, 132, 134, 136 may be provided at spaced apart locations on the bottom surface of cooling plate 120. At least one, and preferably each of cooling fins 130, 132, 134, 136 is cooled by forced convection. Preferably, each cooling fin is provided with its own cooling fan 138, 140, 142, 144 which are preferably individually controlled. It will be appreciated that some cooling fins may be cooled by a single fan and, alternately, that some of the fans maybe controlled as a group. By varying the speed of fans 138, 140, 142, 144, differential cooling may be applied to different portions of cooling plate 120. It will be appreciated that different portions of the mold may be cold by alternate means, such as by providing cooling flow passages through cooling plate 120 and/or mold 70 (as exemplified in FIG. 21) or that any other cooling technique known in the molding art may be used. A cooling fluid (e.g. a chilled refrigerant, which may be liquid or gas) may be passed through such tubes.

In operation, a sheet of thermoformable plastic 82 may be held against mold 70 by any means known in the art such as clamping member 118. Heating oven 150, which has electric heating coils 152, or any other heat source known in the art, moves across mold 70 in a first direction of travel as represented by arrow 146. The oven stops when it is positioned above mold 70, where it stays for a preset amount of time or until a sensor confirms that substrate 82 has reached a preset temperature or until an operator otherwise determines that oven 115 has been in position for a sufficient amount of time or any other method known in the art, at which time oven 150 moves in the reserve direction of travel, as represented by arrow 148, until it reaches a position where it is not positioned above mold 70. As such, it will be appreciated that oven 150 dwells above mold 70 above cooling pin 136 for a greater period of time then it dwells above cooling pin 134. Similarly, oven 150 dwells above mold 70 above cooling pin 134 for a greater period of time then oven 150 dwells above cooling pin 132 and, similarly, oven 150 dwells above mold 70 above cooling pin 132 for a greater period of time then above cooling pin 130. Accordingly, the portion of substrate 82 above cooling pin 136 maybe heated to a substantially greater temperature than the portion of substrate 82 above cooling pin 130.

The size, configuration, and/or orientation of cooling pins 130, 132, 134 and 136, and/or the amount of forced convection or cooling provided thereto, may be adjusted so as to maintain a uniform, or a more uniform temperature in all portions of substrate 82. Preferably, cooling fins extend perpendicular to the direction of motion of oven 150. It will be appreciated that each cooling fin 130, 132, 134, 136 may comprise a plurality of individual cooling fins that are arranged in a line that extends perpendicular to the direction of travel of oven 150. Alternately, for example, fan 144 may have a larger fan blade than fan 138 and/or it may be operated at a higher rpm so as to provide more cooling air to cooling fin 136 than is provided to cooling fin 130 by fan 138. Alternately, or in addition, the surface area of cooling fin 136 may be greater than the cooling area of pin 130. It will also be appreciated that no cooling fin may be positioned where cooling fin 130 is shown as being provided in FIG. 20. By using any one or more of these variations, the cooling rate of the mold adjacent cooling fin 136 where oven 150 has the greatest dwell time is greater there by allowing greater cooling to the portion of substrate 82 above cooling thin 136.

Preferably, the variation in temperature between any portion of substrate 82 would be no more than 25° F., or preferably no more than 15° F., and most preferably no more than 15° F. if the substrate is about 0.01 inches thick. It will be appreciated that the temperature differential that is utilized may be selected based upon the thermoformable substrate that is utilized during the molding process. For example, it has been found that if the temperature variation across the mold is less than 25° F., that a sheet of poly vinyl chloride which is 0.01 inches thick will result in a reproduction 18 having uniform texture across its surface whereas if the substrate is 0.1 inch thick polystyrene, similar uniformity is obtained when the temperature differential of the substrate during the molding process is less than 15° F.

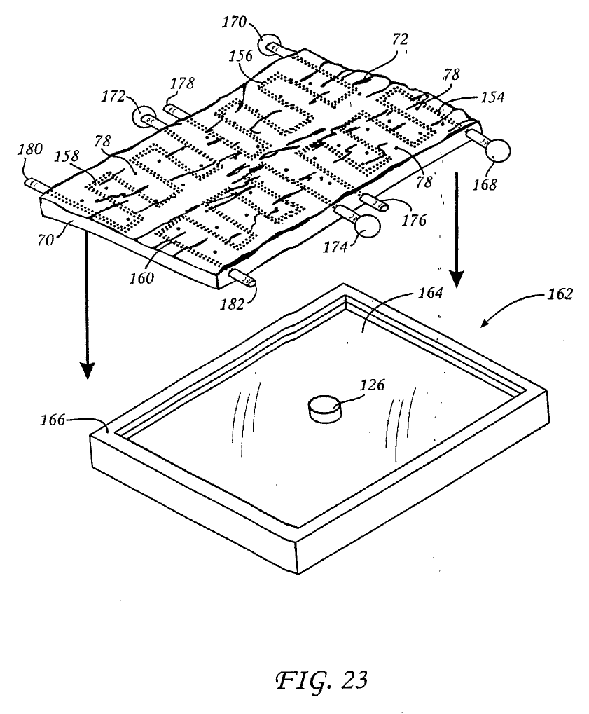

In the embodiment of FIGS. 23 and 24, cooling channels are provided in mold 70 itself. As shown therein, a series of groves 154, 156, 158 and 160 are provided in the under side of mold 70, such as by machining. Vent holes 78 are provided in mold 70 such that none of them pass through or otherwise interfere with any of the grooves. Mold 70 is mounted on base 162. Mold 70 and base 162 are configured such that an angular space or cavity 164 is provided. For example, base 162 may be provided with a raised ridge on which mold 70 seats. During vacuum molding, or combined pressure and vacuum molding, air is withdrawn through holes 78, through angular space 164 and through one or more vent holes 126. A series of valves 168, 170, 172 and 174 are preferably used to control the flow rate of coolant through grooves 154, 156, 158 and 160 respectively. The outlets 176, 178, 180 and 182 of the grooves preferably lead to a common sump or other heat exchanger to maintain the temperature of the coolant preferably within a predetermined range. Preferably, the temperature of the coolant is maintained between 35-100° F., more preferably 45-75° F., and most preferably 55-65° F. Any coolant known in the art may be utilized. The amount of coolant delivered to each region of mold 70 may accordingly be varied so as to maintain a more uniform temperature in substrate 82 . . . k as referred to previously. It will also be appreciated that the coolant that is provided to each zone may be in a separate flow loop wherein each coolant is at a different temperature. Accordingly, instead of varying the flow rate of a common coolant through each of the grooves, each groove may be supplied with a coolant at a different temperature thereby, permitting a similar flow rate through each groove. Alternately, one or more grooves may be provided with a coolant at a different temperature and the flow rates individually controlled so as to provide a desired temperature profile to mold 70 so as to produce a uniform or essentially uniform temperature in substrate 82 as referred to herein. It will be appreciated that a combination of different cooling methods may be utilized to cool a single mold 70 during the molding operation. Accordingly, for example, both cooling pins and grooves could be provided.

In accordance with another aspect of the instant invention, one or more texturing materials may be provided to at least one portion of the substrate so as to enhance the appearance of the reproduction 18. This aspect of the invention may be used if the substrate is not resized from an original, or if a substrate is resized but the same scale factor is used for all axis or if the reproduction in not textured. The texturing material may be one or more of metal foil, metal particles, ground clear glass, fragmented clear glass, ground coloured glass, fragmented coloured glass, clear silicon, coloured silicon, wood particles in a binder, and stone particles in a binder. By providing such texturing material, the image surface of reproduction 18 may more closely recreate or simulate diamonds, (e.g. the use of crushed glass, crushed cubic zirconium or crushed industrial diamonds), elements which are made of metal (by using metal foil or metal particles), wood (by using wood particles and/or fine wood dust preferably in a binder), stone or concrete (by using stone particles preferably a binder), and cloth, fine cloth fibers and/or leather to simulate clothing, shoes or other items made from these materials.

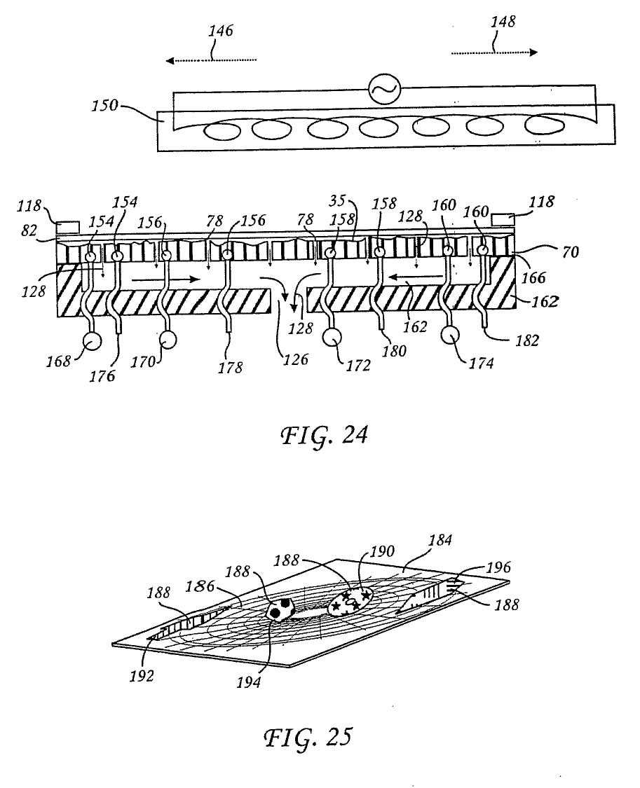

Referring to FIG. 25, substrate 184 has an art image 186 that has been printed thereon. Adhesive 188 has been provided on a plurality of regions of the image bearing surface of substrate 184, such as by being printed thereon. In particular, the adhesive 188 has been applied in regions 190, 192, 194 and 196 where textural enhancement is desired. The adhesive may be any suitable adhesive known in the art. The adhesive may be a water based air dried adhesive such as 3M Fastbond, and other air dried adhesive such as Silalph 340™, a heat activated adhesive such as ethylene vinyl acetate (EVA) or an ultraviolet light curable adhesive such as Noelle UV 17.

Once the artwork adhesive is applied and ready to accept one or more texturing materials, the texturing materials may be applied by any means known in the art. The materials may be applied only to the regions to which the adhesive has been applied. Alternately, the texturing material maybe applied to the entire surface or a substantial portion of the surface of substrate 184. In such a case, the textural material will only remain in place where it contacts adhesive 188. The remaining portion of the texturing material may be removed, such as by air borne transport and recycled. Other techniques such as electrostatic flocking may be used.

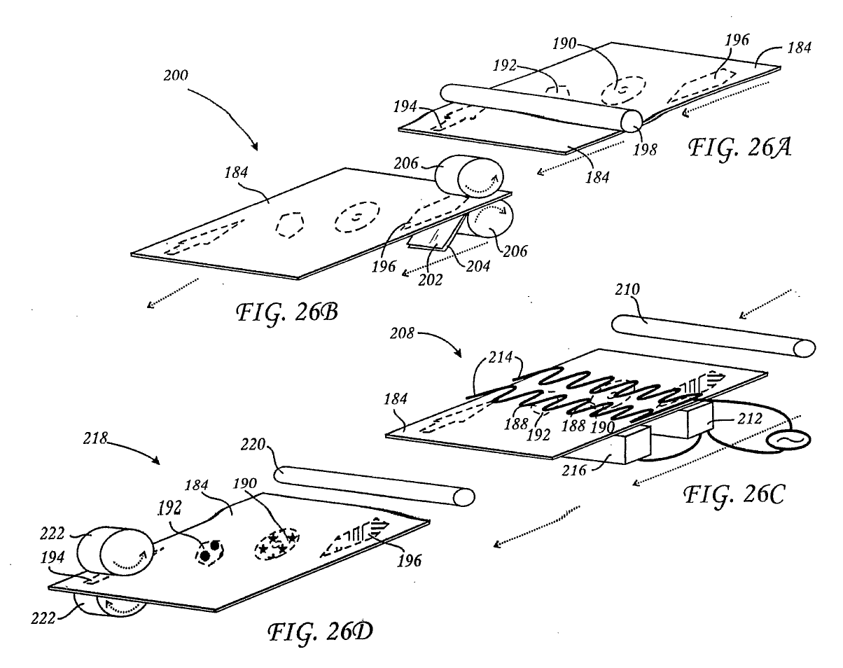

In the embodiment of FIGS. 26A-26D, a heat activated adhesive is utilized and several different techniques are exemplified. Each of these techniques may be used individually, or in any combination or sub-combination. At station 200, metal foil 202, which is provided on a plastic substrate 204, is applied to region 196 by passing the metal foil 202 and substrate 184 between motorized rollers 206. This process creates the visual appearance of metal in region 196. In station 208, additional texturing material is provided by electrostatic flocking. At station 208, additional portions of adhesive 188 are heated by heating element 210. Substrate 184 is then passed between hoppers 212, 216 and ground electrode 214 so as to create electrostatic fields on the inner surface of substrate 184. Accordingly, finely ground glass powder may be allowed to adhere to region 190 thereby creating the visual appearance of diamonds. Finely ground ceramic powder may be adhered to region 192 thereby creating the visual appearance of a stone finish. Subsequently, substrate 184 may then be passed to a further station 218 where a heating element 220 heats adhesive 188 which is placed in region 194. At station 218, leather may be applied by rollers 222 to region 194 so as to create the illusion of a leather finish. One or more of the rollers may have a textured finish so as to emboss or otherwise deform the leather to provide a desired finish therein.

Accordingly, it will be appreciated that different texturing materials can be provided in different regions to simulate various materials. It will also be appreciated substrate 184 after having material applied in regions 190, 192 may be passed between rollers such that the texturing material applied to those regions may have a smooth finish. It will be appreciated that other application methods may be utilized.

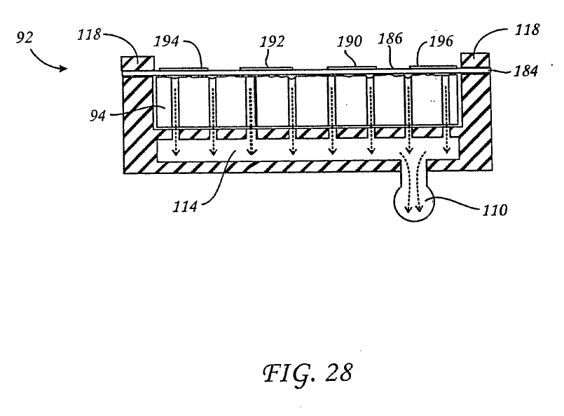

Subsequently, the printed substrate with the textured material provided thereon may be subjected to a molding operation, such as vacuum molding as shown in FIG. 28, to create a three-dimensional geometry or topography of the substrate 184 in addition to the textured material added to regions 190, 192, 194 and 196. As shown in FIG. 28, the texturing material is placed in molding station 92 so that the rear surface (the non-image bearing surface) of substrate 184 is in contact with mold 94. It will be appreciated that, in such a case, mold 94 may contain a male image that is to be reproduced in substrate 184. In an alternate embodiment, it will be appreciated that the image bearing face of substrate 184 may be in contact with mold 94 whereby a female mold may be utilized. In a further alternate embodiment, it will be appreciated that the texturing material may be applied to substrate 184 subsequent to the topography being provided in substrate 184 proving such a case, it is preferred that the texturing material is provided by means other than rollers so as not to damage the image formed in substrate 184.

In addition to using a molding operation to prepare the substrate, the substrate maybe alternately be prepared by a computer directing a machine to apply a variable mechanical force to the substrate so as to produce a plurality of depths in the Z dimension. The variable mechanical force may be produced by a printing head, such as a dot matrix printing head, a daisy wheel printing head, by a plurality of pins or an eclectic deformable LCD whereby a computer signal will result in a physically member contacting and depressing the substrate at different locations. Prior to the substrate being subjected to the variable mechanical pressure, the rigidity of the substrate may be reduced as discussed herein, such as by increasing the temperature of the substrate or the addition of a chemical additive or by exposure to steam.

In accordance with this embodiment of the invention, the substrate may be cellulose based or a thermoformable plastic and, preferably is a thermoformable plastic. While the use of molds as discussed herein is advantageous if a large number of reproductions is required, the use of molds may be prohibitively expensive if only a single reproduction is required or, alternately, a short production run is required (e.g. up to about 100 reproductions). In such a case, a three dimensional topographical relief may be produced by using, e.g., a dot addressable print head such as those used in dot matrix printers. By controlling the power applied to each pin or each part of the printing head, and the duration during which the power is applied and/or the temperature of the substrate, the depth of the relief being produced can be controlled.

Preferably, the substrate is first printed with an image, or an image is otherwise applied to a substrate, prior to producing the three dimensional topographical map. By moving either the print head only, the print head and the substrate, or only the substrate, in conjunction with the control of the firing of the pins portions of the printing head, the desired three dimensional relief pattern can be created at the appropriate locations on the image. An alternate printing technique that could be utilized would be to incorporate an electromagnetically movable member (e.g. a hammer) and a rotatable die member, which incorporates a series geometric shapes. The electromagnetically member may move with respect to the die member such that, when an appropriate die member is positioned in an appropriate location of the substrate, the electromagnetically movable member contacts the die and presses it into the substrate so as to create a relief pattern in the substrate. Accordingly, the depth of the relief that is reproduced can be controlled by controlling the power applied to the electromagnetically movable member and/or the duration during which power is applied to the electromagnetically movable member, thereby adjusting the force with which the electromagnetically movable member contact's the die members and the speed at which the electromagnetically movable member contacts the die member. By controlling the temperature of the substrate, the depth of the relief produced in the reproduction can also be adjusted. It will be appreciated that this technique may be applied to a substrate that has been molded or a substrate that has no image printed thereon or wherein the substrate subsequently has an image applied thereto. The following example are exemplary and non-limiting.

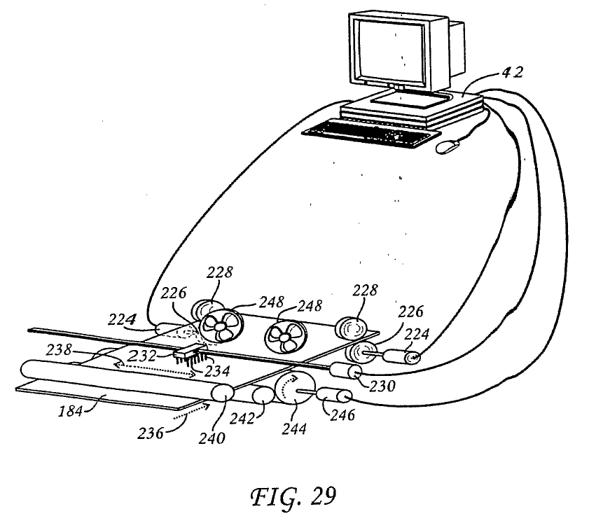

For example, as shown in FIG. 29, computer 42 controls drive motors 224 which are drivingly connected to rollers 226. Substrate 184 passes between rollers 226 and 228. Accordingly, computer 42 can control the rate of travel and direction of travel of substrate 184. Computer 42 also controls motor 230, which is drivingly connected to print head 232, which has a plurality of pins 234. Motor 230 may be used to cause print head 232 to travel transversally, in the direction indicated by arrow 238, so that print head 232 may traverse the entire width of substrate 184. As substrate 184 travels in the direction of arrow 236, substrate 184 passes proximate to heating element 240, which heats substrate 184. At the same time, heating element 242 may heat drum 244 which may have an outer layer that is made of a mechanically deformable heat resistant material, such as neoprene rubber. Drum 244 is rotated by motor 246 and motor 246 is controlled by computer 42. Thus as thermoformable plastic sheet 184 moves in direction 236, it is heated to a temperature which allows it to be readily deformable without destruction of the substrate, at which time the pins 234 of print head 232 are sequentially or systematically fired, as may be directed by computer 42, as the print head 232 is positioned at the required locations by computer 42 to create a three dimensional topography of, e.g., an original art work. It will be appreciated that, in an alternately embodiment, print head 232 may extend across the entire width of substrate 184 and, accordingly, may not require movement transversely in the direction of arrow 238.

Accordingly, substrate 184 may first be passed through, e.g. an ink jet printer, to have an image printed thereon and subsequently through, e.g., a dot matrix printer for creating a three dimensional topography at the desired or required locations on the image printed on substrate 184.

By moving either the print head 232 and/or substrate 184, in conjunction with controlling the firing of pins 234 or the like, the desired three dimensional relief pattern can be created in sheet 184. After sheet 184 has the requisite three dimensional pattern formed therein, fans 248, or other cooling member, may be utilized to cool the substrate, or cure a resin in the case of a nonporous substrate, so as to make the three dimensional pattern durable.

It would be appreciate that if substrate 184 is cellulose based, then heating element 240 may also be utilized to apply steam to substrate 284 and/or an alternate steam delivery member may be provide. The cellulose based substrate may optionally have a layer of thermoformable material adhered to it, or impregnated into it, to assist the mechanically deformation process and the subsequent retention of the mechanically deformation.

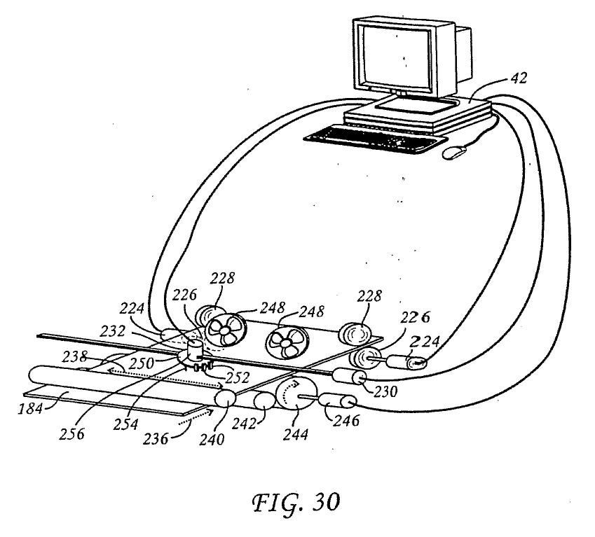

In the embodiment shown in FIG. 30, print head 232 comprises a rotating die member 250, which has a plurality of shapes 252, which are preferable three dimensional shapes, around its perimeter. Print head 232 also includes at least one and preferably a plurality of firing pins 254 as well as motor 256. The firing pins 254 and rotating die member 250 are similar to those of daisy wheel printers and typewriters. When a die member 250 having a desired or pre-selected or predetermined three dimensional shape 252 is positioned at the correct location above the image on substrate 184, computer 42 will cause a single to be sent so that an appropriately aligned firing pin 254 to cause a selected three dimensional shape 252 to strike substrate 184 thereby producing a deformation in substrate 184.

Accordingly, an advantage of this aspect of the invention is that a substrate, which may be a single sheet or a continuous roll that may after treatment be cut into individual sheets, may be treated to provide a relief pattern. It will be appreciated, that the computer 42 may direct the member that deforms the substrate using a work file having XYZ data wherein the XY data is scaled using a first scale factor, or a first and third scale factor, and disclosed herein and the Z data is scaled using a second scale factor as taught herein.

In accordance with a further embodiment of this invention, the substrate may comprise a frame member (e.g. a planar or fanciful member that extends around all or substantially all of the perimeter of a substrate) so as to produce both the substrate with the image, and optionally enhancements, a scaled image and/or a textured relief pattern, simultaneously with a frame for the substrate. Alternately, a frame may be prepared separate using one or more of the techniques set out herein on a different substrate and subsequently combined with the reproduction to produce a final reproduction suitable for hanging on the wall or the like.

In accordance with another method of the instant invention, it would be appreciated that the reproduction may be prepared at a different location from where the original or object is prepared. Accordingly, the work image may be produced at a first location and stored in a computer readable file (e.g. a PDF file). The computer readable file may then be sent, such as by e-mail to a second location where the reproduction is produced, such as by a publisher or other person operating the required equipment. Alternately, one or more pictures may be taken at a first location and then sent to a second location where the work file is prepared. The work file may then be used at that location to prepare the reproduction or the reproduction may be prepared at a further location. For example, a manufacture of a consumer product (e.g. beer, clothing, perfume and the like) may have an advertisement prepared e.g. such as the image shown in FIG. 11. This image may be a two dimensional picture or may be a picture that has a topography therein. The computer readable file may then be e-mailed to a publisher or other operator of the equipment who may then produce a reproduction as shown in FIG. 11 wherein the reproduction includes a topography. The publisher may then ship the reproduction to the person who produced the advertisement or the client who had the advertisement prepared.

In another embodiment, this method may be used by a company to print pictures that are taken by an individual. Accordingly, instead of developing pictures as is known in the art, the pictures may be developed on a substrate that has a topography. For example, the pictures may be taken on film and dropped of at a store or laboratory where the film is developed. The developed film may then be used to produce the electronic data representing a work image which may then be used in the same location to produce the three dimensional reproductions. Alternately, the developed may be converted to a CD and shipped to a printer. Alternately, the data may be digitized and sent via e-mail to a printer. Alternately, if a consumer is using a digital camera, they may merely e-mail a digital picture or pictures to the printer. Once a work file is obtained, it may be processed by one or more of the techniques set out herein. Preferably a dot matrix printer or other variable force application machine is utilized.

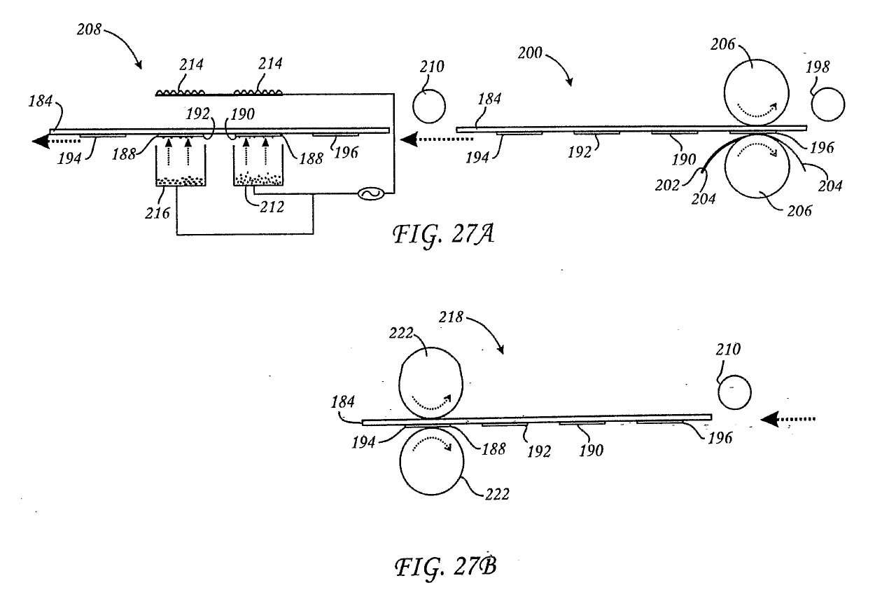

In another embodiment, this technique could be utilized in a custom portrait studio. For example, a person may attend a studio to have a picture of themselves or a member of their family or their entire family taken. The resulting image (whether on film or a digital picture) may then be utilized to produce a picture on a substrate wherein the substrate has a relief so that one or more, and preferably all, of the person or persons or animals or combination thereof, which are present in the picture, or any other elements present in the picture, are provided in relief. In order to produce such reproduction, it is preferred to use the data to directly drive a printing head or the like to produce the reproduction, such as is shown for example in FIGS. 27 and 28. Alternately, the data could be provided to a rapid prototyping machine which would then produce a three dimensional reproduction of the family.

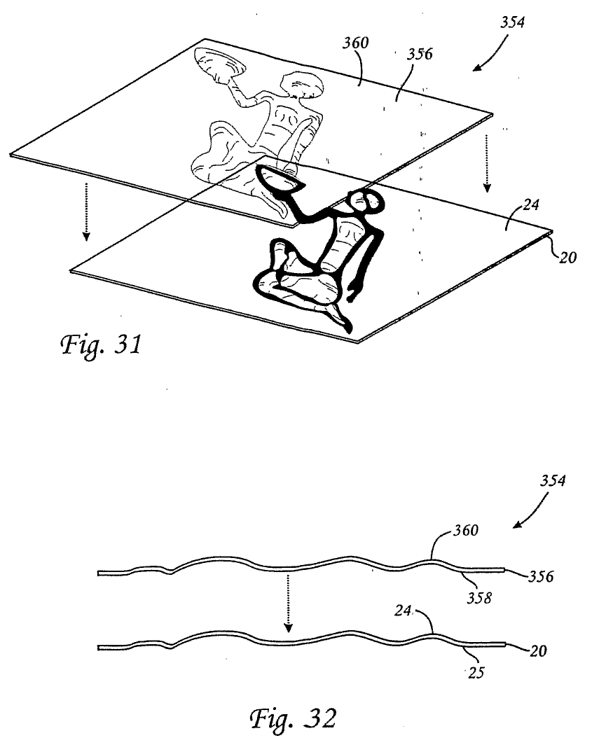

In accordance with the embodiment of FIGS. 31 and 32, composite work 354 comprises a substrate 20 that is provided with a cover sheet 356 having a mounting surface 358, for being secured to image bearing surface 24 of substrate 20, and a top surface 360. In the embodiment of FIGS. 40 and 41, a bottom sheet 362 having a mounting surface 364, for being secured to rear face 25 of substrate 20, and a rear surface 366.

Cover sheet 356 and bottom sheet 362 may be secured or releasably secured to substrate 20 by any means known in the art, such as by an adhesive or by being laminated to each other during the molding process in which substrate 20 is produced.

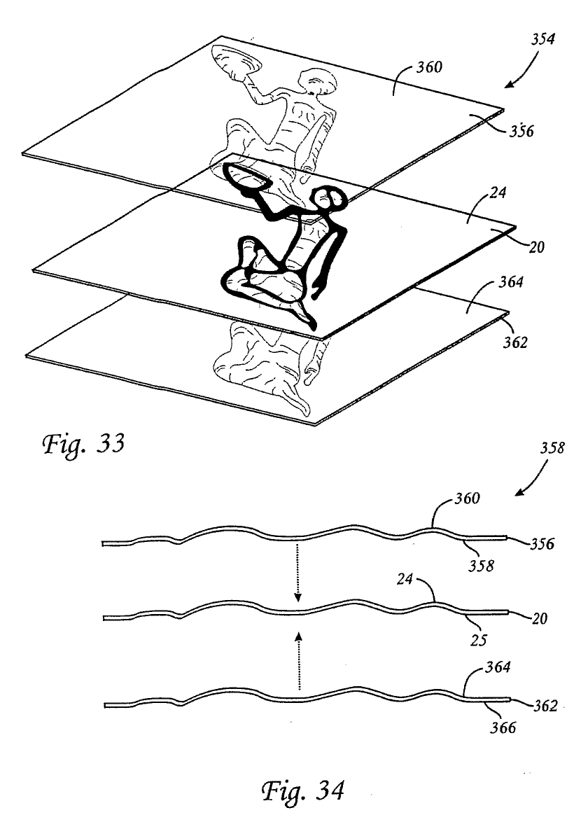

As shown in FIGS. 33-34, cover sheet 356 and bottom sheet 362 each have the same image formed therein as substrate 20. Accordingly, image surface 24 and rear surface 25 of substrate 20 are in intimate contact. Preferably, each of cover sheet 356 and bottom sheet 362 are a material that can provide additional dimensional stability to substrate 20. Alternately, cover sheet 356 and bottom sheet 362 may be provided to enhance the durability of substrate 20 such as by providing a thin coating to prevent surfaces 24, 25 of substrate 20 from being scratched. If substrate 20 is cellulose based, then each of cover sheet 356 and bottom sheet 362 are preferably made of plastic thereby adding water resistance to substrate 20. Accordingly, the composite work 354 may be used as trading cards (i.e., cards that contain a picture of a hockey player, basketball player, football player, etc. as well as information typically appearing on trading cards such as information about the player) wherein at least a portion of the material is provided in three-dimensions—e.g., the picture of the player may be a three-dimensional picture, or a team emblem, or the composite work may be a substrate bearing an Olympic emblem or a national flag or religious emblem may be created in 3D.

It will be appreciated that if image substrate 20 has a relatively low profile, or if sheets 356, 362 are sufficiently thin and/or elastic, then cover sheets 356, 362 need not be subjected to any pretreatment steps to provide a three-dimensional image therein but may merely be applied over image bearing surface 24 and conform to the topography of image bearing surface 24 as each sheet 356, 362 is applied. In such a case, sheets 356, 362 may merely provide a scratch resistant coating of, e.g., plastic and not add to the dimensional stability of substrate 20.

It will be understood that various additions and modifications may be made to the products and methods disclosed herein and each is within the scope of the following claims. In particular, it will be appreciated that each of the constructions herein may be used in any particular application disclosed herein.

It will be appreciated that any aspect of the invention, namely the configuration of a substrate to have a holographic appearance, the scaling of a substrate, the addition of texturing material to a substrate, and the methods of, manufacture may be used individually or in any combination of two or more aspects.

It will be appreciated that, in one embodiment, the techniques may be used with an artwork that is computer generated. In addition, the artwork need not be an original oil painting or water colour. The original artwork may be a design for wallpaper, greeting cards or other mass-produced material bearing an artistic design. Preferably, however, the work file is of one or more persons and/or animals.

It would be appreciated that if the enhancements are provided in addition to the production of a topography, scaling or the provision of textural materials as disclosed herein, that the enhancements and any other techniques may be provided in any particular order.

1. A method of forming an image in planes X, Y and Z on a substrate, the substrate having an outer surface, the method comprising:
(a) acquiring electronic data representing a work image of an object, the work image including a three dimensional representation of the object;
(b) using the electronic data to prepare a three dimensional reproduction of the object on the outer surface wherein the three dimensional reproduction extends in the Z plane with respect to the outer surface and wherein (1) the substrate is shaped and (2) the selection of the outer surface bearing a positive or a negative of the work image is made, so that the three dimensional representation has a holographic appearance.

2. The method of claim 1 further comprising preparing the reproduction such that the outer surface of the substrate bears a negative version of the work image.

3. The method of claim 1 further comprising providing a picture on the outer surface of the substrate.

4. The method of claim 1 wherein the electronic data includes information on colour to be applied to the substrate and the method further comprises providing colour to the outer surface of the substrate.

5. The method of claim 1 further comprising shaping the substrate such that the outer surface is generally concave when viewed from the front.

6. The method of claim 1 wherein the electronic data is acquired by taking a picture of the object.

7. The method of claim 6 further comprising using a camera to take the picture of the object.

8. The method of claim 7 further comprising converting the picture taken by the camera to the electronic data.

9. The method of claim 1 further comprising receiving the electronic data over the Internet.

10. The method of claim 1 further comprising receiving the electronic data on a portable data storage medium.

11. The method of claim 6 wherein the object comprises at least one of an animal, a mammal and an article of manufacture and the method further comprises using the substrate as an advertisement.

12. The method of claim 1 wherein the work image includes a three dimensional representation of the object, wherein in the representation of the object has a length in each of the X and Y planes and a plurality of depths in the Z plane and the method further comprises processing the electronic data to obtain scaled XYZ data wherein at least one of X and Y are scaled by a first scale factor and Z is scaled by a second scale factor, the second scale factor being different from the first scale factor and using the scaled XYZ data in step (b) to prepare the reproduction of the object on the substrate.

13. The method as claimed in claim 12 wherein the reproduction has a texture and the method further comprises selecting the second scale factor so that the texture is perceptible.

14. The method as claimed in claim 12 wherein the object is a person and a first value for the second scale factor is used for at least one of the person's lips and eyebrows and a second value for the second scale factor is used for the person's nose.

15. The method as claimed in claim 1 wherein the object bears a two-dimensional image and the method further comprises producing the work image from the two dimensional image.

16. The method as claimed in claim 1 wherein the object comprises a photograph or sketch of an object and the method further comprises producing the work image from the photograph or sketch.

17. The method as claimed in claim 1 wherein the work image is produced at a first location and stored in a computer readable file and the computer readable file is sent to a second location where the reproduction is produced.

18. The method as claimed in claim 17 wherein the second location is physically remote from the first location and the computer readable file is sent via a data transmission network.

19. The method as claimed in claim 18 wherein the reproduction is subsequently shipped to a customer.

20. A method of forming an image on a substrate, the substrate having a front face, the method comprising:
(a) acquiring electronic data representing a work image of an object, the work image including a three dimensional representation of the object; and,
(b) using the electronic data to prepare a three dimensional topographical reproduction of the object on the substrate wherein the front face of the substrate displays a negative version of the work image and the substrate is shaped so that the front face is generally concave when viewed from the front.

21. A method of operating a photographic studio comprising:
(a) obtaining an image of at least one living animal or mammal
(b) using the image to produce a 3D version of the image on a substrate.

22. The method as claimed in claim 21 wherein the method further comprises applying a two dimensional version of the image on a substrate and subsequently treating the substrate to obtain the 3D version of the image.

23. The method as claimed in claim 21 wherein the substrate is a deformable material and the method further comprises subjecting the substrate to pressure to form the 3D version of the image therein.

24. The method as claimed in claim 23 further comprising treating the substrate to temporarily reduce the rigidity of the substrate.

25. The method as claimed in claim 24 wherein the substrate comprises a thermoformable plastic and the method further comprises subjecting the substrate to heat and pressure to form the 3D version of the image therein.

26. The method as claimed in claim 24 wherein the substrate comprises a cellulose substrate and the method further comprises subjecting the substrate to heat in the presence of water to form the 3D version of the image therein.

27. The method as claimed in claim 21 wherein the 3D version of the image is formed using rapid prototyping technology.

28. The method as claimed in claim 21 wherein the image is obtained from a two dimensional photograph and the method further comprises obtaining a work image from the two dimensional photograph and processing the work image to includes a three dimensional representation of the at least one living animal or mammal, wherein in the representation of the object has a length in each of the X, and Y dimensions and a plurality of depths in the Z dimension.

29. The method as claimed in claim 21 wherein the image is obtained by photographing at least one living animal or mammal at the photographic studio.

30. The method as claimed in claim 21 wherein the at least one living animal or mammal comprises a person and the method further comprises configuring the substrate to have a holographic appearance.
